(19) United States
(12) Patent Application Publication
(10) Pub. No.: US 2023/0396604 A1
(43) Pub. Date: Dec. 7, 2023

(54) METHOD FOR PERFORMING USER AUTHENTICATION AND DEVICE FOR PERFORMING SAME

(71) Applicant: Samsung Electronics Co., Ltd., Suwon-si (KR)

(72) Inventors: Daehaeng CHO, Suwon-si (KR); Eunyoung KWON, Suwon-si (KR); Hakhyun KIM, Suwon-si (KR); Donghoon LEE, Suwon-si (KR)

(21) Appl. No.: 18/452,866

(22) Filed: Aug. 21, 2023

Related U.S. Application Data
(63) Continuation of application No. PCT/KR2022/002592, filed on Feb. 22, 2022.

(30) Foreign Application Priority Data
Feb. 23, 2021 (KR) 10-2021-0024365

(51) Int. Cl. H04L 9/40; H04L 9/32

(52) U.S. Cl. CPC H04L 63/0823; H04L 9/3234

(57) ABSTRACT

A method for performing user authentication by a terminal is provided. The method includes receiving, by one secure application among at least one secure application installed in a secure area of the terminal, a user authentication request, identifying whether a valid user authentication result corresponding to the user authentication request exists, and in response to there being no valid user authentication result corresponding to the user authentication request, requesting a user authentication result from a user authentication module installed in the secure area, and providing, by the user authentication module, a user authentication result corresponding to the user authentication request to the secure application that has received the user authentication request or to the at least one secure application installed in the secure area of the terminal.

### CROSS-REFERENCE TO RELATED APPLICATION(S)

This application is a continuation application, claiming priority under § 365(c), of an International application No. PCT/KR2022/002592, filed on Feb. 22, 2022, which is based on and claims the benefit of a Korean patent application number 10-2021-0024365, filed on Feb. 23, 2021, in the Korean Intellectual Property Office, the disclosure of which is incorporated by reference herein in its entirety.

### BACKGROUND

### 1. Field

The disclosure relates to a method of performing user authentication and a device for performing the user authentication.

### 2. Description of Related Art

In a 5^{th}-generation (5G) or beyond-5G environment, as a terminal is capable of providing various functions, services made available through the terminal may also be diversified. Among the services made available through the terminal, a service that requires a user authentication result may be included. To this end, the terminal needs to include a secure area to manage user authentication results.

The secure area may refer to an area where operations requiring a secure authentication procedure can be performed. For example, it may refer to an area where information about a user authentication result is provided when a financial transaction, such as payment or remittance or a task of transmitting or receiving a secure document is performed. Moreover, various types of user authentication results are required to enhance security, and for this purpose, one or more secure applications may be installed in the secure area of a terminal. Accordingly, there is a need for a technique for more effectively managing user authentication results used in at least one secure application.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for performing user authentication in a terminal.

Additional aspects will be set forth in part in the description which follows and, in part, will be apparent from the description, or may be learned by practice of the presented embodiments.

In accordance with an aspect of the disclosure, a method, performed by a terminal, of performing authentication is provided. The method includes receiving, by one secure application among at least one secure application installed in a secure area of the terminal, a user authentication request, identifying whether a valid user authentication result corresponding to the user authentication request exists, in response to there being no valid user authentication result corresponding to the user authentication request, requesting, by the secure application that has received the user authentication request, a user authentication result from a user authentication module installed in the secure area, and providing, by the user authentication module, a user authentication result corresponding to the user authentication request to the secure application that has received the user authentication request or to the at least one secure application installed in the secure area of the terminal.

In accordance with another aspect of the disclosure, a terminal for performing user authentication is provided. The terminal includes a communication module, a memory storing one or more instructions, at least one processor configured to execute the one or more instructions stored in the memory, and a secure circuitry connected to the at least one processor, wherein one secure application among at least one secure application installed in a secure area of the secure circuitry is configured to receive a user authentication request via a framework in a normal area of the processor, identify whether a valid user authentication result corresponding to the user authentication request exists, and in response to there being no valid user authentication result corresponding to the user authentication request, request a user authentication result from a user authentication module installed in the secure area, and the user authentication module is configured to provide a user authentication result corresponding to the user authentication request to the secure application that has received the user authentication request or to the at least one secure application installed in the secure area of the terminal.

In accordance with another aspect of the disclosure, a computer program product includes a recording medium having stored therein a program that causes a terminal to perform a method of performing user authentication is provided. The method includes receiving, by one secure application among at least one secure application installed in a secure area of the terminal, a user authentication request, identifying whether a valid user authentication result corresponding to the user authentication request exists, in response to there being no valid user authentication result corresponding to the user authentication request, requesting, by the secure application that has received the user authentication request, a user authentication result from a user authentication module installed in the secure area, and providing, by the user authentication module, a user authentication result corresponding to the user authentication request to the secure application that has received the user authentication request or to the at least one secure application installed in the secure area of the terminal.

According to various embodiments disclosed herein, by operating a user authentication module that manages user authentication results in a secure area of a terminal, the user authentication results may be provided in a secure and flexible manner. In addition, various effects identified directly or indirectly through this document may be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram of a terminal performing a user authentication method according to an embodiment of the disclosure;

FIG. 1B is a conceptual diagram illustrating a user authentication method according to an embodiment of the disclosure;

FIG. 2 is a flowchart of a user authentication method according to an embodiment of the disclosure;

FIG. 3 is a diagram illustrating certificates and signing keys used in a user authentication method according to an embodiment of the disclosure;

FIG. 4 is a flowchart illustrating an operation of registering a certificate and a signing key for user authentication among a service server, a key management system server, and a terminal according to an embodiment of the disclosure;

FIG. 5 is a flowchart illustrating an operation in which a user authentication module exchanges, with a service server, a certificate and a signing key necessary for encrypting and providing a user authentication result according to an embodiment of the disclosure;

FIG. 6 is a flowchart illustrating an operation in which a user authentication module updates a service provider certificate indicating a service provider according to an embodiment of the disclosure;

FIG. 7 is a flowchart illustrating an operation in which a framework updates a service provider certificate indicating a service provider according to an embodiment of the disclosure;

FIG. 8 is a flowchart illustrating an operation in which a framework updates a user authentication request verification certificate used to verify a user authentication request according to an embodiment of the disclosure;

FIG. 9 is a flowchart illustrating an operation in which an application updates a terminal certificate used to validate a terminal according to an embodiment of the disclosure;

FIG. 10 is a flowchart illustrating an operation performed when a terminal receives a user authentication request from an external electronic device according to an embodiment of the disclosure;

FIG. 11A is a flowchart of a method, performed by a terminal, of performing user authentication and providing a user authentication result according to an embodiment of the disclosure;

FIG. 11B is a flowchart of a method, performed by a terminal, of performing user authentication and providing a user authentication result according to an embodiment of the disclosure;

FIG. 12 is a flowchart illustrating an operation performed when a terminal receives a user authentication request from an application in a normal area according to an embodiment of the disclosure; and

FIG. 13 is a block diagram of a terminal in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

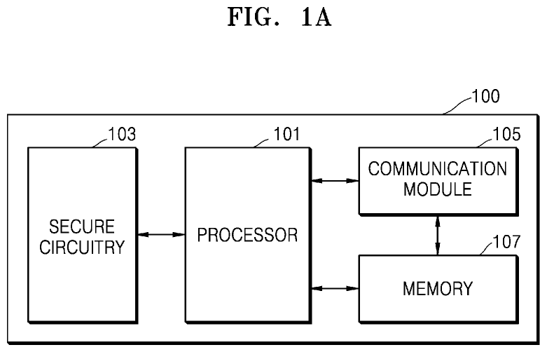

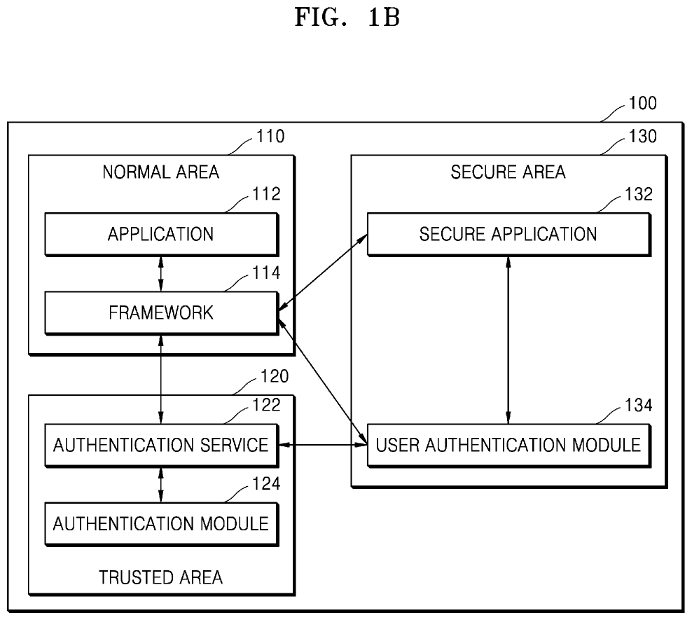

FIG. 1A is a block diagram of a terminal performing a user authentication method according to an embodiment of the disclosure.

Referring to FIG. 1A, a terminal 100 may include a processor 101, secure circuitry 103, a communication module 105, and a memory 107. All components shown in FIG. 1A are not essential components of the terminal 100. The terminal 100 may be implemented with more or fewer components than those shown in FIG. 1A.

The processor 101 generally controls all operations of the terminal 100. For example, the processor 101 may execute programs stored in the memory 107 to control all operations of a normal area (e.g., a normal area 110 of FIG. 1B) and a trusted area (e.g., a trusted area 120 of FIG. 1B) located on the processor 101, the secure circuitry 103, and the communication module 105.

The normal area may be configured based on an operating system (OS) generally installed on the terminal 100 and may be a rich execution environment (REE) in which applications that do not require special security are executed. At least one application and a framework may be installed in the normal area in the form of a module. The trusted area is a trusted execution environment (TEE) in which applications requiring security are executed, and may be configured based on a secure OS that conforms to the TEE standard. An authentication module and an authentication service module may be installed in the trusted area. However, the location of the normal area and the trusted area on the processor 101 is merely an example, and the trusted area may be located on a separate and independent circuit according to another embodiment. According to another embodiment of the disclosure, the trusted area may be located in the secure circuitry 103.

The secure circuitry 103 is hardware independent of the processor 101 and may be connected to the processor 101 through a physical channel. A secure area (an embedded secure processor) may reside in the secure circuitry 103. The secure area may provide security functions that allow only a pre-authenticated person to view data and have a user authentication module and at least one secure application installed therein. The secure area may provide, for example, security functions for simple payment services, near field communication (NFC) applications, or the like, but these are merely an example, and secure applications executed through the secure area are not limited to the above example.

Operations performed by at least one application, a framework, an authentication module, an authentication service, at least one secure application, and/or a user authentication module of the terminal 100 are described below with reference to FIGS. 1B, 2 to 10, 11A, 11B, and 12.

The communication module 105 may include one or more components that enable communication with other electronic devices and other external devices. For example, the communication module 105 may include at least one of a short-distance wireless communication unit or a mobile communication unit.

The short-range wireless communication unit may include, but is not limited to, at least one of a Bluetooth communication unit, a Bluetooth low energy (BLE) communication unit, an NFC unit, a wireless local area network (WLAN) (or wireless-fidelity (Wi-Fi)) communication unit, a ZigBee communication unit, an infrared data association (IrDA) communication unit, a wi-fi direct (WFD) communication unit, an ultra-wideband (UWB) communication unit, or an Ant+communication unit.

The mobile communication unit may transmit or receive a wireless signal to or from at least one of a base station, another electronic device, and an external server on a mobile communication network. In this case, the wireless signal may include various types of data, such as the user authentication request, a certificate of the terminal, and a signed message.

The memory 107 may store programs that cause the terminal 100 to perform a method of performing user authentication. In addition, the memory 107 may store data required for user authentication. For example, the memory 107 may store at least one of a certificate of the terminal 100 or a security key.

The memory 107 may include at least one type of storage medium from among a flash memory-type memory, a hard disk-type memory, a multimedia card micro-type memory, a card-type memory (e.g., a secure digital (SD) card or an extreme digital (XD) memory), a random access memory (RAM), a static RAM (SRAM), a read-only memory (ROM), an electrically erasable programmable ROM (EEPROM), programmable ROM (PROM), a magnetic memory, a magnetic disc, and an optical disc.

FIG. 1B is a conceptual diagram illustrating a user authentication method according to an embodiment of the disclosure.

Referring to FIG. 1B, the terminal 100 may perform user authentication by operating a normal area 110, a trusted area 120, and a secure area 130. As described above with reference to FIG. 1A, the normal area 110 and the trusted area 120 may be located on a processor (e.g., the processor 101 of FIG. 1A), and the secure area 130 may be located on a secure circuitry (e.g., the secure circuitry 103 of FIG. 1A) which is hardware independent of the processor.

Environments in which applications are executed are classified into the normal area 110, the trusted area 120, and the secure area 130 based on security levels, and the accessibility and compatibility of each area may be determined according to its security level. The normal area 110 has a lower security level than those of the trusted area 120 and the secure area 130, and may be implemented relatively easily due to its good accessibility and compatibility. The trusted area 120 may have a security level higher than that of the normal area 110 and lower than that of the secure area 130. The trusted area 120 may be included in the terminal 100 in the form of hardware or software. In addition, the secure area 130 has the highest security level among the above-described areas, and may be included in the terminal 100 in the form of hardware separate from the normal area 110 and the trusted area 120.

An application may be a collection of command codes built for a specified purpose. It may be necessary to perform various functions for a specified purpose, and areas in which command codes constituting an application are executed may be different according to a required security level for each of the functions. For example, a function of displaying a user interface (UI) in an application or a function of receiving and displaying open information from a server is a function that requires a relatively low security level, and command codes for performing the corresponding functions may be executed in the normal area 110. Furthermore, a function of performing authentication with a user requires a certain level of security, and thus, command codes for performing the corresponding function may be executed in the trusted area 120. A function of managing a user authentication result, a certificate for verifying the user authentication result, and a signing key requires a high level of security, and accordingly, the function may be executed in the secure area 130 having the highest security level among the above-described areas. Hereinafter, for convenience of description, a set of command codes executed for a specified function in the normal area 110 is referred to as an application 112, and a set of command codes executed for a specified function in the secure area 130 is referred to as a secure application 132. The secure application 132 may be in the form of an applet running on an embedded secure element (eSE).

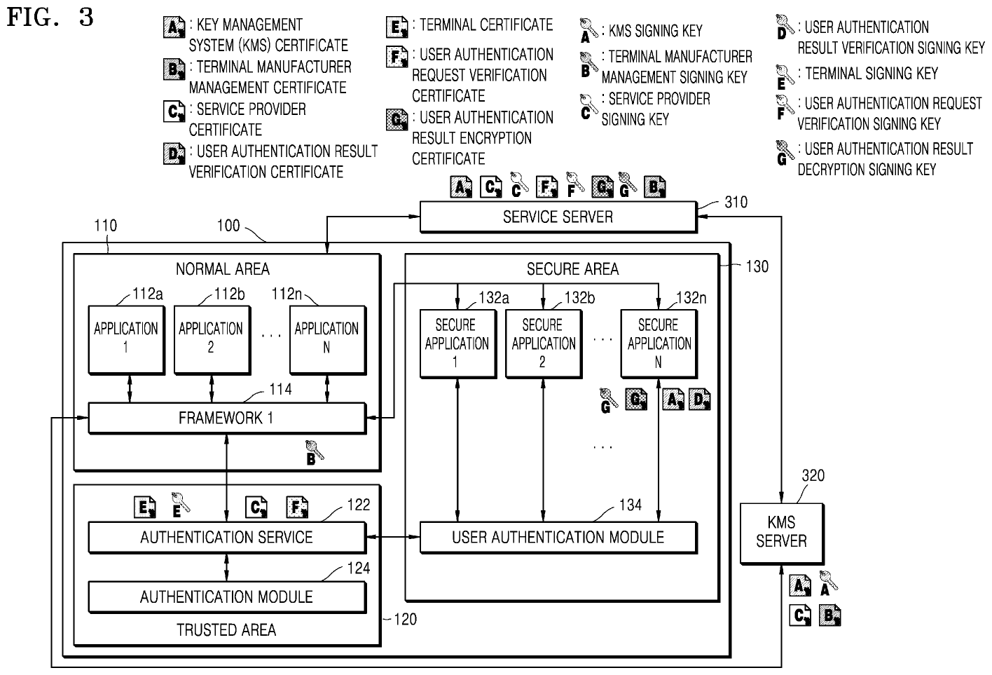

When a request for a service requiring a user authentication result is received via the application 112 in the normal area 110, an authentication service 122 in the trusted area 120 may perform user authentication. The authentication service 122 may perform user authentication through an authentication module 124, return a user authentication result, and manage a terminal key and a terminal certificate as described later with reference to FIG. 3. The authentication module 124 is a software or hardware module that performs user authentication and may obtain authentication information, such as a personal information number (PIN), a password, and biometric information from the user.

According to an existing method, the authentication service 122 in the trusted area 120 transmits a user authentication result directly to the secure application 132, or through the application 112 or a framework 114 in the normal area 110 to the secure application 132. Here, the framework 114 is a module that provides a fundamental technology necessary for the application 112 executed in the normal area 110 to perform operations, and may perform caller authentication for executing command code.

In the existing method whereby the secure application 132 receives a user authentication result directly from the authentication service 122 in the trusted area 120, firmware of the terminal 100 needs to be updated each time a secure application is added or modified. This may lead to a decrease in user convenience, and when a plurality of secure applications are operated, user convenience may be significantly deteriorated. Furthermore, when the application 112 or framework 114 in the normal area 110 transmits a user authentication result to the secure application 132 in the secure area 130, even if a security protocol is used, the normal area 110 may be relatively more exposed to security threats due to the nature of the normal area 110 with good accessibility.

Accordingly, the terminal 100 according to an embodiment seeks to address the above-described issues by operating the user authentication module 134 for managing a user authentication result within a secure area 130. According to an embodiment of the disclosure, the user authentication module 134 may receive a user authentication result returned by the authentication service 122 from the framework 114 and provide the received user authentication result to the secure application 132. In this case, if there are a plurality of secure applications installed in the secure area 130 and the user authentication result is not restricted to a specified secure application, the user authentication module 134 may broadcast the user authentication result so that the user authentication result may be provided to each of the plurality of secure applications. In addition, the terminal 100 may encrypt a message including the user authentication result with a certificate and a key unique to the user authentication module 134, or sign the message before transmitting the message, thereby preventing the level of security from deteriorating.

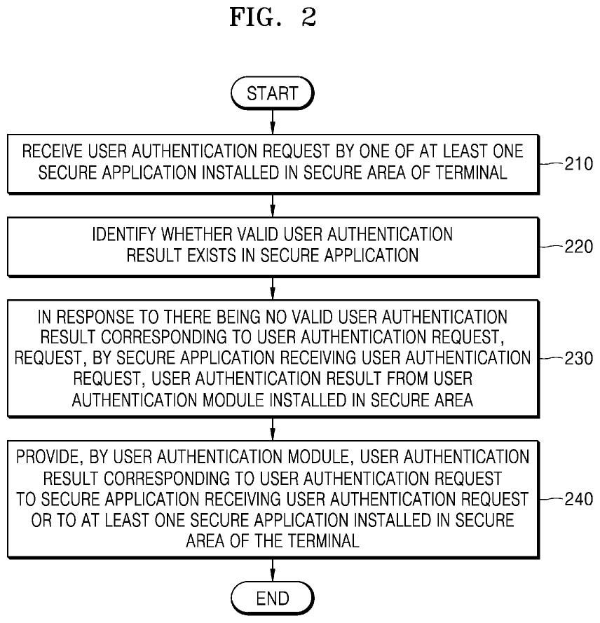

Moreover, because FIG. 1B shows some of the components of the terminal 100 necessary to describe a user authentication method according to an embodiment of the disclosure, the components of the terminal 100 is not limited to the embodiment of FIG. 1B. Hereinafter, operations related to a user authentication module, according to an embodiment of the disclosure, are described with reference to FIGS. 2 to 10, 11A, 11B, 12, and 13.

FIG. 2 is a flowchart of a user authentication method according to an embodiment of the disclosure.

Referring to FIG. 2, in operation 210, one secure application among at least one secure application installed in a secure area of a terminal may receive a user authentication request. According to an embodiment of the disclosure, when the user authentication request originates from an external electronic device, the user authentication request may be transmitted from the external electronic device to a secure application via a framework in a normal area of the terminal. According to another embodiment of the disclosure, when the user authentication request originates from an application in the normal area, the user authentication request may be transmitted from the application in the normal area to a secure application via the framework.

In operation 220, the secure application receiving the user authentication request may identify whether a valid user authentication result corresponding to the user authentication request exists.

When receiving the user authentication request, the secure application may identify whether a valid user authentication result exists in the secure application. The validity of the user authentication result may be determined according to a preset condition. For example, a reference counting value, whether a timer expires, or whether a secure area is reset may correspond to a preset condition. When the referencing counting value is set as a condition, the user authentication result may be identified as valid if the number of uses of the user authentication result stored in the secure application does not exceed a maximum count value, and the referencing count value may be incremented by 1 each time the user authentication result is used. For example, when the maximum count value is 5, the user authentication result may be used up to 5 times, and if the number of uses of the user authentication result exceeds 5, the user authentication result is determined to be invalid and user authentication may be performed again. In another example, when whether the secure area is reset is set as a condition, a user authentication result obtained before the secure area is reset may be determined to be invalid after the secure area is reset.

In operation 230, in response to there being no valid user authentication result corresponding to the user authentication request, the secure application that has received the user authentication request may request a user authentication result from a user authentication module installed in the secure area.

On the other hand, when the user authentication result is identified as valid, the secure application may provide the user authentication result to the external electronic device or application in the normal area.

In operation 240, the user authentication module may provide a user authentication result corresponding to the user authentication request to the secure application that has received the user authentication request or to the at least one secure application installed in the secure area of the terminal.

According to an embodiment of the disclosure, the user authentication module may transmit, according to settings, the user authentication result directly to the secure application that has received the user authentication request. However, this is merely an embodiment of the disclosure, and the user authentication module may broadcast the user authentication result to a plurality of secure applications installed in the secure area, or multicast it to specified secure applications, so that other secure applications may also use the user authentication result.

Moreover, the secure application receiving the user authentication result from the user authentication module may identify the validity of the received user authentication result. A method, performed by the secure application, of identifying the validity of the user authentication result may be the same as described above in operation 220. If the user authentication result received from the user authentication module is valid, the secure application may transmit it to the external electronic device or application in the normal area. In another example, when the user authentication result received from the user authentication module is not valid, user authentication needs to be performed. The user authentication may be performed by an authentication service and an authentication module in a trusted area, as described above with reference to FIG. 1A, and a user authentication result newly obtained as a result of performing the user authentication may be transmitted to the secure application via the user authentication module.

In various embodiments disclosed herein, until a user authentication result is transmitted to an external electronic device or an application in the normal area that has requested the user authentication result, various certificates and signing keys may be used by each of the modules executed in the normal area, the trusted area, and the secure area to more safely process pieces of information required for user authentication. Hereinafter, various certificates and signing keys used for a user authentication process in the disclosure are described with reference to FIG. 3.

FIG. 3 is a diagram illustrating certificates and signing keys used in a user authentication method according to an embodiment of the disclosure.

Referring to FIG. 3, to perform a user authentication method according to an embodiment of the disclosure, a certificate and a signing key may be stored in at least one module included in a terminal 100. Here, the at least one module may include, for example, a framework 114, an authentication service 122, a secure application (e.g., 132n), and a user authentication module 134. The function of each component included in the terminal 100 of FIG. 3 may be the same as that described with reference to FIG. 1A, a plurality of applications 112a, 112b, and 112n may be operated in a normal area 110, and a plurality of secure applications 132a, 132b, and 132n corresponding to the plurality of applications 112a, 112b, and 112n in the normal area 110 may be operated in a secure area 130.

Certificates and signing keys used for user authentication according to an embodiment may be preset in the terminal 100 or generated by the terminal 100, and may be injected from a service server 310 or a key management system (KMS) server 320.

The service server 310 is a server managed by a service providing entity and may be an issuer of a certificate indicating a service provider (hereinafter referred to as a service provider certificate), a certificate used to verify a user authentication request (hereinafter referred to as a user authentication request verification certificate), and a certificate used by the user authentication module 124 to encrypt a user authentication result (hereinafter referred to as a user authentication result encryption). The service provider may enter into a contract with an application provider that develops each of at least one application to be installed on the terminal 100 and provide services related to the application to the terminal 100.

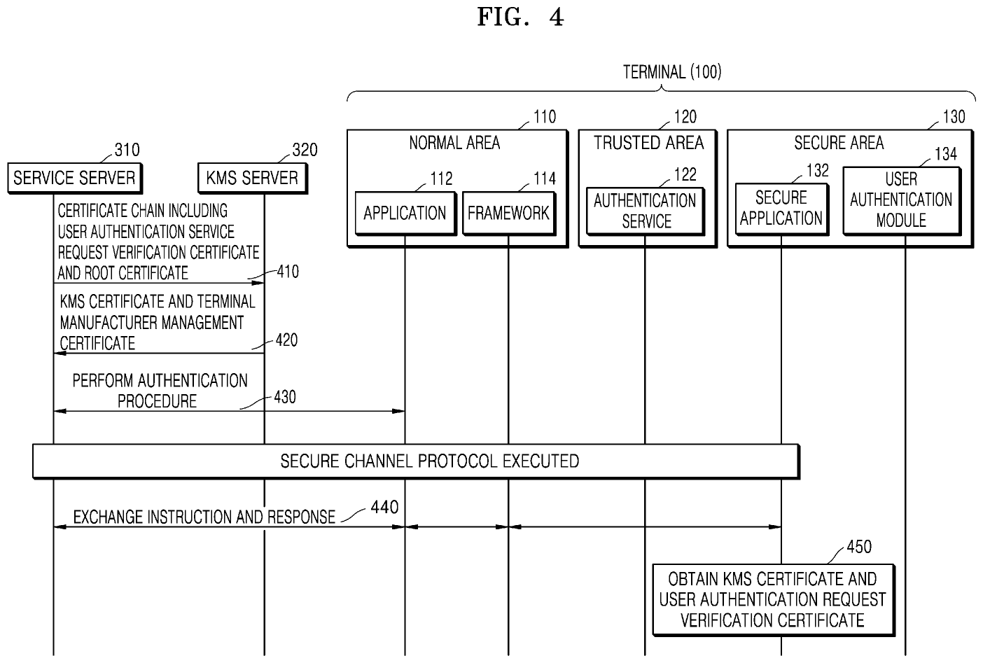

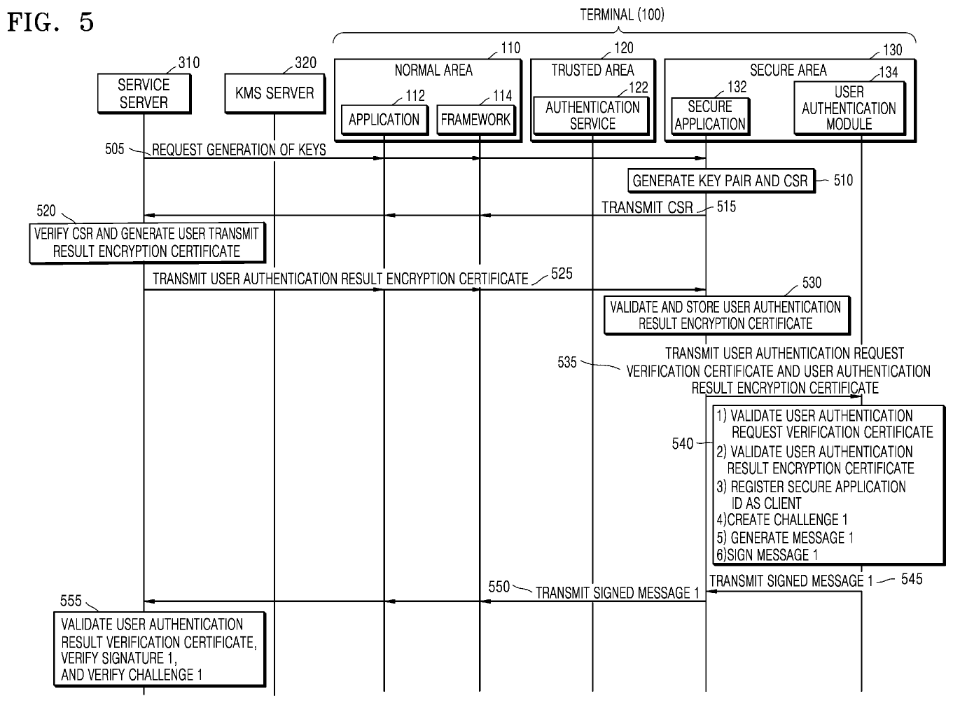

The KMS server 320 may inject signing keys into the user authentication module 124 via end-to-end communication, and at this time, an encryption communication protocol may be applied for security. Specific operations of injecting certificates and signing keys into the terminal 100 are described later with reference to FIGS. 4 and 5, and in the embodiment of FIG. 3, the purpose of each of the plurality of certificates and a corresponding signing key is described.

A KMS certificate may be a certificate generated and managed by the KMS server 320. The KMS certificate may be injected into the secure application (e.g., 132a) via the service server 310, and may be used by the secure application (e.g., 132a) to verify a result received from the user authentication module 124. For example, the KMS certificate may be used to validate a user authentication result verification certificate as described below.

A KMS signing key is a signing key corresponding to the KMS certificate and may be used to issue the KMS certificate.

A terminal manufacturer management certificate may be a certificate generated and managed by a manufacturer of the terminal 100 in a secure environment (e.g., a hardware security module (HSM)). The terminal manufacturer management certificate may be used to verify a terminal certificate as described later. In addition, the terminal manufacturer management certificate may be managed by the service server 310, and in this case, the terminal manufacturer management certificate managed by the service server 310 may be used by the application (e.g., 112a) or the service server 310 to verify a resulting value from the authentication service 122.

A terminal manufacturer management signing key is a signing key corresponding to the terminal manufacturer management certificate and may be used to issue the terminal manufacturer management certificate.

A service provider certificate may be a certificate indicating a service provider.

A service provider signing key is a signing key corresponding to the service provider certificate and may be used to sign a user authentication request verification certificate as described later.

The user authentication result verification certificate may be used to verify a user authentication result transmitted by the user authentication module 134.

A user authentication result verification signing key is a signing key corresponding to the user authentication result verification certificate, and may be used to sign the user authentication result.

A terminal certificate is a certificate managed by the authentication service 122, which may be generated externally and injected into the terminal 100 during a process for the terminal 100.

A terminal signing key is a signing key corresponding to the terminal certificate, and may be generated externally and injected into the terminal 100 during the manufacturing process of the terminal 100.

A user authentication request verification certificate may be a certificate used to verify a user authentication request.

A user authentication request signing key is a signing key corresponding to the user authentication request verification certificate, and may be used to sign the user authentication request.

A user authentication result encryption certificate may be used by the user authentication module 134 to encrypt the user authentication result.

A user authentication result decryption signing key is a signing key corresponding to the user authentication result encryption certificate and may be used to decrypt the encrypted user authentication result.

Among the above-described certificates, the KMS certificate may have a certificate chain relationship with the user authentication result verification certificate. For example, the validity of the user authentication result verification certificate may be verified using the KMS certificate. In addition, the terminal manufacturer management certificate may have a certificate chain relationship with the terminal certificate. For example, the validity of the terminal certificate may be verified using the terminal manufacturer management certificate. In addition, the service provider certificate, the user authentication request verification certificate, and the user authentication result encryption certificate may have a certificate chain relationship with one another. The validity of the user authentication request verification certificate may be verified using the service provider certificate, and the validity of the user authentication result encryption certificate may be verified using the user authentication request verification certificate.

Moreover, as shown in FIG. 3, the above-described certificates and signing keys may be generated and managed by the service server 310, the KMS server 320, and the terminal 100 according to their respective purposes, and are described below with reference to FIGS. 4 and 5.

FIG. 4 is a flowchart illustrating an operation of registering a certificate and a signing key for user authentication among a service server, a KMS server, and a terminal, according to an embodiment of the disclosure.

Referring to FIG. 4, in operation 410, the service server 310 may provide the KMS server 320 with a certificate chain including a user authentication service request verification certificate and a root certificate (e.g., a service provider certificate) required for validating the corresponding certificate.

In operation 420, the KMS server 320 may provide a KMS certificate and a terminal manufacturer management certificate to the service server 310. The KMS certificate may be injected into the secure application 132 via the service server 310. The secure application 132 may verify a result received from the user authentication module 134 by using the KMS certificate. The terminal manufacturer management certificate may be used to validate a terminal certificate, which is a certificate unique to the terminal 100.

In operation 430, an authentication procedure may be performed between the service server 310 and the application 112 in the normal area 110 of the terminal. The authentication procedure may include, for example, a login process or a card registration process by which a user's identity can be proved. When the authentication procedure is successfully performed, a secure channel protocol may be executed between the service server 310 and the secure area 130, and the secure application 132 may be installed in the secure area 130 via the secure channel protocol.

In operation 440, a command and a response thereto may be exchanged between the service server 310 and the secure application 132. In an embodiment of the disclosure, the command may include pieces of information necessary for installing and configuring the secure application, and also include certificates required for a user authentication operation. According to an embodiment of the disclosure, the command or the response thereto from the service server 310 may be received via the application 112 in the normal area 110 and transmitted to the secure application 132 via the framework 114. In addition, when the secure application 132 transmits a command or response to the framework 114 in the normal area 110, the command or response may be transmitted from the framework 114 to the service server 310 via the application 112.

In operation 450, the secure application 132 may obtain the KMS certificate and the user authentication request verification certificate via the operation 440.

Through the above-described operations, the secure application 132 may be installed in the secure area 130 of the terminal 100, and a certificate required for user authentication may be injected into the secure application 132 from the service server 310.

FIG. 5 is a flowchart illustrating an operation in which a user authentication module exchanges, with the service server 310, a certificate and a signing key necessary for encrypting and providing a user authentication result, according to an embodiment of the disclosure.

Referring to FIG. 5, in operation 505, the service server 310 may request the secure application 132 to generate keys. The key generation request may be received via the application 112 in the normal area 110 and forwarded to the secure application 132 via the framework 114.

In operation 510, when receiving the key generation request, the secure application 132 may generate a key pair and a certificate signing request (CSR). The key pair may include a user authentication result encryption certificate used by the user authentication module 134 to encrypt a user authentication result and a user authentication result decryption signing key used to decrypt the encrypted user authentication result. The CSR may include an identifier (ID) of the secure application.

In operation 515, the secure application 132 may transmit the CSR to the service server 310. When the secure application 132 transmits the CSR to the framework 114 in the normal area 110, the CSR may be forwarded from the framework 114 to the service server 310 via the application 112. However, this is merely an example, and the key pair and the CSR may be generated by the service server 310.

In operation 520, the service server 310 may verify the CSR and generate a user authentication result encryption certificate by using a user authentication request signing key.

In operation 525, the service server 310 may transmit the user authentication result encryption certificate to the secure application 132 in the secure area 130. The user authentication result encryption certificate may be received via the application 112 in the normal area 110 and transmitted to the secure application 132 via the framework 114.

In operation 530, the secure application 132 may validate the user authentication result encryption certificate, and store the validated user authentication result encryption certificate.

In operation 535, the secure application 132 may transmit a user authentication request verification certificate and the user authentication result encryption certificate to the user authentication module 134. The user authentication request verification certificate may be injected from the service server 310 as described above in operation 450 of FIG. 4.

In operation 540, the user authentication module 134 may validate the certificates received from the secure application 132 and store the certificates used to verify the user authentication result.

According to an embodiment of the disclosure, the user authentication module 134 may validate the user authentication request verification certificate received from the secure application 132 by using a service provider certificate according to the certificate chain relationship described above with reference to FIG. 3. The service provider certificate may be obtained from the service server 310 in the operation of installing the secure application 132, which is described above with reference to FIG. 4, and may be obtained from the KMS server 320 according to another embodiment.

When the service provider certificate is verified as valid, the user authentication module 134 may validate the user authentication result encryption certificate by using the user authentication request verification certificate. The user authentication request verification certificate and the user authentication result encryption certificate that are validated to be valid may be stored in the user authentication module 134. When the user authentication result encryption certificate is verified as valid, the user authentication module 134 may register the ID of the secure application 132 as a client ID.

The user authentication module 134 may generate challenge 1. In various embodiments of the disclosure, a challenge may be generated to verify validity, and the operation of generating the challenge may mean an operation of generating a preset number of random bits between the user authentication module 134 and the service server 310. In addition, the user authentication module 134 may generate message 1 including the identifier of the secure application 132, the challenge 1, and the user authentication result verification certificate which is a certificate used to verify the user authentication result. The user authentication module 134 may sign the message 1 (with signature 1) by using SK.UVM.AUT signing key.

In operation 545, the user authentication module 134 may transmit the signed message 1 to the secure application 132.

In operation 550, the secure application 132 may then transmit the signed message 1. The transmitted message 1 may be received by the framework 114 in the normal area 110, and may be transmitted from the framework 114 to the service server 310 via the application 112.

In operation 555, the service server 310 may validate the user authentication result verification certificate by using a KMS certificate. When the user authentication result verification certificate is validated to be valid, the service server 310 may verify the signature 1 by using the user authentication result verification certificate. Furthermore, when the signature 1 is verified as valid, the service server 310 may verify the challenge 1 generated by the user authentication module 134.

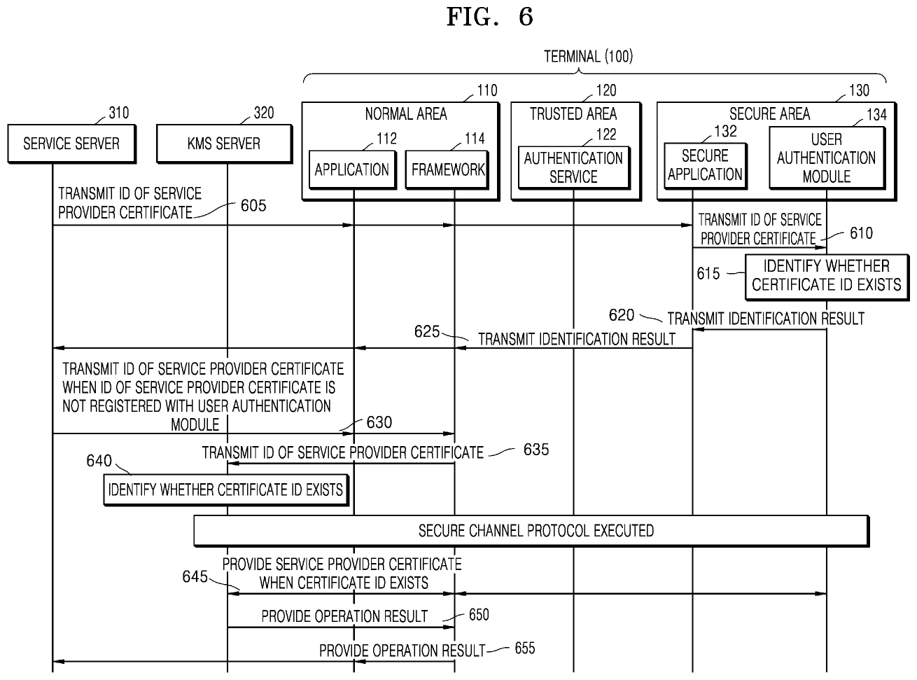

FIG. 6 is a flowchart illustrating an operation in which a user authentication module updates a service provider certificate indicating a service provider, according to an embodiment of the disclosure.

Referring to FIG. 6, in operation 605, the service server 310 may transmit an ID of a service provider certificate to the secure application 132 in the secure area 130. The service provider certificate may be received via the application 112 in the normal area 110 and transmitted to the secure application 132 via the framework 114.

In operation 610, the secure application 132 may transmit the ID of the service provider certificate to the user authentication module 134. Moreover, in an embodiment of the disclosure, the ID of the service provider certificate is an example of information for specifying the service provider certificate, and other information used to specify the service provider certificate may be transmitted in addition to the ID of the service provider certificate.

In operation 615, the user authentication module 134 may identify whether the ID of the service provider certificate exists. To this end, the user authentication module 134 may compare an ID of at least one prestored service provider certificate with the ID of the service provider certificate received from the secure application 132.

In operation 620, the user authentication module 134 may transmit, to the secure application 132, a result of identification regarding whether the ID of the service provider certificate exists.

In operation 625, the secure application 132 may transmit, to the service server 310, the result of the identification regarding whether the ID of the service provider certificate received from the user authentication module 134 exists. The result of the identification regarding whether the ID of the service provider certificate exists may be received by the framework 114 in the normal area 110 and then transmitted from the framework 114 to the service server 310 via the application 112.

In operation 630, when the ID of the service provider certificate is not registered in the user authentication module 134, the service server 310 may transmit the ID of the service provider certificate to the framework 114. The ID of the service provider certificate may be transmitted to the framework 114 via the application 112 in the normal area 110.

On the other hand, when the ID of the service provider certificate is registered in the user authentication module 134, the service server 310 may not perform an additional operation for registering the service provider certificate in the user authentication module 134.

In operation 635, the framework 114 may transmit the ID of the service provider certificate to the KMS server 320.

In operation 640, the KMS server 320 may identify whether the ID of the service provider certificate received from the framework 114 exists. For this purpose, the KMS server 320 may compare an ID of at least one prestored service provider certificate with the ID of the service provider certificate ID received from the framework 114.

In operation 645, when the ID of the service provider certificate received from the framework 114 exists, the KMS server 320 may provide the service provider certificate to the user authentication module 134. To this end, a secure channel protocol may be executed between the KMS server 320 and the terminal 100. The service provider certificate in the KMS server 320 may be transmitted to the user authentication module 134 via the framework 114.

On the other hand, when the ID of the service provider certificate received from the framework 114 does not exist, the KMS server 320 may determine that an error has occurred.

In operation 650, the KMS server 320 may transmit a result of operation related to the ID of the service provider certificate to the framework 114. The KMS server 320 may transmit a result of operations 640 and 645 described above to the framework 114. For example, the KMS server 320 may notify the framework 114 that it has provided the service provider certificate to the user authentication module 134. According to another example, the KMS server 320 may notify the framework 114 that an error has occurred because the ID of the service provider certificate does not exist in the KMS server 320.

In operation 655, the framework 114 may transmit, to the service server 310, the result of operation related to the ID of the service provider certificate received from the KMS server 320. The result of the operation related to the ID of the service provider certificate may be transmitted to the service server 310 via the application 112 in the normal area 110.

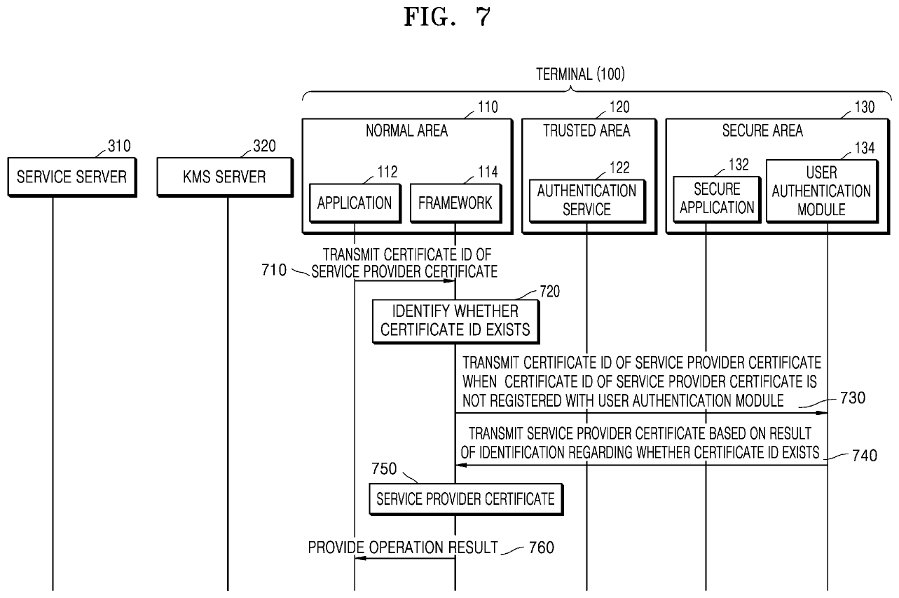

FIG. 7 is a flowchart illustrating an operation in which a framework updates a service provider certificate indicating a service provider according to an embodiment of the disclosure.

Referring to FIG. 7, in operation 710, the application 112 may transmit an ID of a service provider certificate to the framework 114. Moreover, in an embodiment of the disclosure, the ID of the service provider certificate is an example of information for specifying the service provider certificate, and other information used to specify the service provider certificate may also be transmitted in addition to the ID of the service provider certificate.

In operation 720, the framework 114 may identify whether the ID of the service provider certificate received from the application 112 exists.

In operation 730, when the ID of the service provider certificate received from the application 112 is not registered in the framework 114, the framework 114 may transmit the ID of the service provider certificate to the user authentication module 134.

In operation 740, the user authentication module 134 may transmit the service provider certificate to the framework 114, based on a result of the identification regarding whether the ID of the service provider certificate exists.

In operation 750, the framework 114 may store the service provider certificate when receiving the service provider certificate from the user authentication module 134. For example, the framework 114 may store, in a non-volatile memory, the service provider certificate received from the user authentication module 134.

In operation 760, the framework 114 may transmit a result of the operation related to the service provider certificate to the application 112. For example, the framework 114 may notify the application 112 that it has received and stored the service provider certificate from the user authentication module 134. According to another example, when the service provider certificate has been registered in the framework 114 in operation 730, the framework 114 may notify the application 112 that the service provider certificate is registered. However, this is merely one embodiment of the disclosure, and according to another embodiment of the disclosure, if the service provider certificate has been registered in the framework 114, the framework 114 may not provide the application 112 with the result of operation related to the service provider certificate.

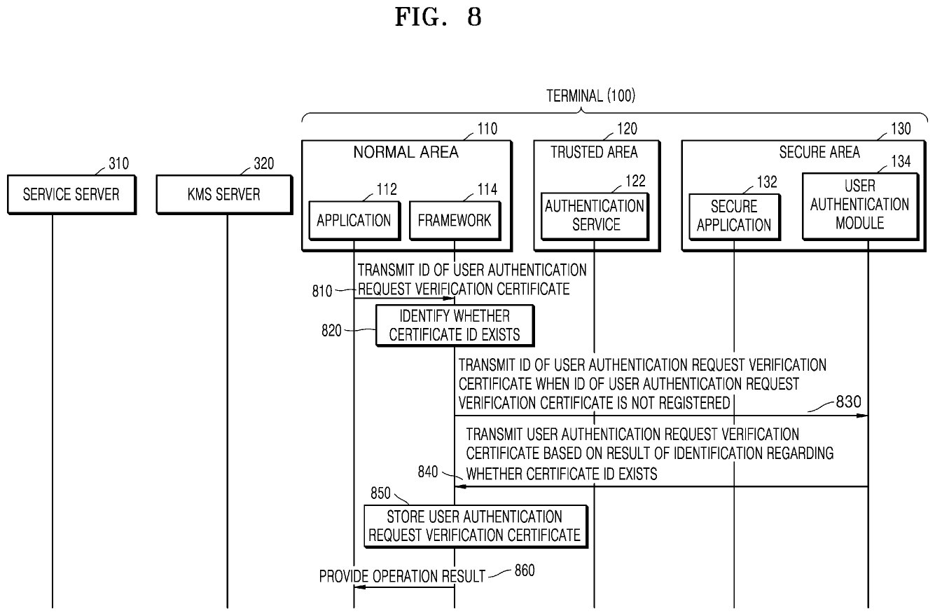

FIG. 8 is a flowchart illustrating an operation in which a framework updates a user authentication request verification certificate used to verify a user authentication request according to an embodiment of the disclosure.

Referring to FIG. 8, in operation 810, the application 112 may transmit an ID of a user authentication request verification certificate to the framework 114. Moreover, in an embodiment of the disclosure, the ID of the user authentication request verification certificate is an example of information for specifying the user authentication request verification certificate, and other information used to specify the user authentication request verification certificate may also be transmitted in addition to the ID of the user authentication request verification certificate.

In operation 820, the framework 114 may identify whether the ID of the user authentication request verification certificate received from the application 112 exists.

In operation 830, when the ID of the user authentication request verification certificate received from the application 112 is not registered in the framework 114, the framework 114 may transmit the ID of the user authentication request verification certificate to the user authentication module 134.

In operation 840, the user authentication module 134 may transmit the user authentication request validation certificate to the framework 114, based on a result of the identification regarding whether the ID of the user authentication request validation certificate exists.

In operation 850, the framework 114 may store the user authentication request verification certificate when receiving the user authentication request verification certificate from the user authentication module 134. For example, the framework 114 may store, in in a non-volatile memory, the user authentication request verification certificate received from the user authentication module 134.

In operation 860, the framework 114 may transmit a result of the operation related to the user authentication request verification certificate to the application 112. For example, the framework 114 may notify the application 112 that it has received and stored the user authentication request verification certificate from the user authentication module 134. According to another example, when the user authentication request verification certificate has been registered in the framework 114 in operation 830, the framework 114 may notify the application 112 that the user authentication request verification certificate is registered. However, this is merely one embodiment of the disclosure, and according to another embodiment of the disclosure, if the user authentication request verification certificate has been registered in the framework 114, the framework 114 may not provide the application 112 with the result of operation related to the user authentication request verification certificate.

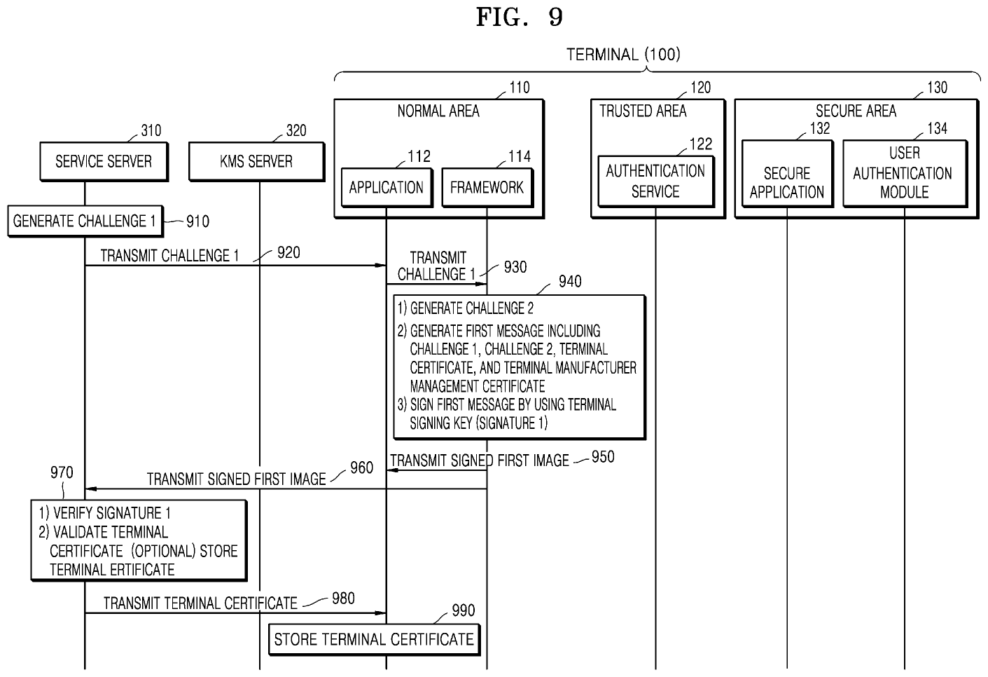

FIG. 9 is a flowchart illustrating an operation in which an application updates a terminal certificate used to validate a terminal according to an embodiment of the disclosure.

Referring to FIG. 9, in operation 910, the service server 310 may generate challenge 1. For example, the service server 310 may perform an operation of generating challenge 1 by generating a preset number of random bits.

In operation 920, the service server 310 may transmit challenge 1 to the application 112 in the normal area 110.

In operation 930, the application 112 may transmit, to the framework 114, the challenge 1 received from the service server 310.

In operation 940, the framework 114 may generate a first message based on the challenge 1.

When receiving the challenge 1, the framework 114 may generate challenge 2. For example, the framework 114 may perform an operation of generating challenge 2 by generating a preset number of random bits.

The framework 114 may generate a first message including the challenge 1, the challenge 2, and a terminal certificate. However, this is merely an example, and the first message may further include a root certificate for a terminal certificate, such as a terminal manufacturer management certificate. The framework 114 may sign the first message (with signature 1) by using a terminal signing key corresponding to the terminal certificate.

In operation 950, the framework 114 may transmit the signed first message to the application 112.

In operation 960, the application 112 may transmit the signed first message to the service server 310.

In operation 970, the service server 310 may validate the terminal certificate from the signed first message. The service server 310 may verify the signature (signature 1) on the message received from the application 112, and validate the terminal certificate based thereon. In addition, according to an embodiment of the disclosure, the service server 310 may store the validated terminal certificate. However, this is merely an example, and the service server 310 may not store the validated terminal certificate.

In operation 980, the service server 310 may transmit the terminal certificate to the application 112.

In operation 990, the application 112 may store the terminal certificate received from the service server 310.

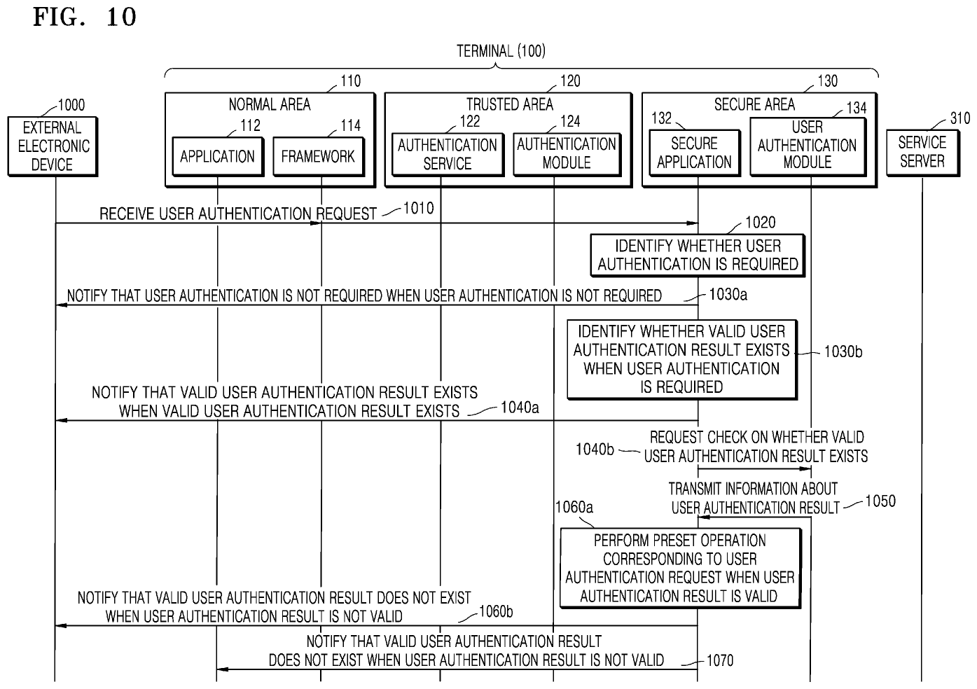

FIG. 10 is a flowchart illustrating an operation performed when a terminal receives a user authentication request from an external electronic device according to an embodiment of the disclosure.

Referring to FIG. 10, in operation 1010, an external electronic device 1000 may transmit a user authentication request to the terminal 100. The external electronic device 1000 may require user authentication by the terminal 100 to perform a specified operation. In this case, the external electronic device 1000 may transmit a user authentication request to the terminal 100. For example, when the external electronic device 1000 is a card reader, the external electronic device 1000 may transmit a user authentication request to the terminal 100 for payment. The user authentication request transmitted by the external electronic device 1000 may be forwarded to the secure application 132 in the secure area 130 via the framework 114 in the normal area 110 of the terminal 100.

In operation 1020, when receiving the user authentication request, the secure application 132 may identify whether user authentication is required. For example, when receiving a user authentication request for a specified operation, the secure application 132 may identify whether user authentication is required to perform the specified operation. Here, the user authentication request may include information that allows the terminal 100 to identify the specified operation.

In operation 1030a, when the user authentication is not required, the secure application 132 may notify the external electronic device 1000 that the user authentication is not required. A message for notifying that the user authentication is not required may be transmitted from the secure application 132 to the external electronic device 1000 via at least one of the application 112 or the framework 114 in the normal area 110. However, this is merely one embodiment of the disclosure, and the secure application 132 may directly transmit, to the external electronic device 1000, the message for notifying that the user authentication is not required.

In operation 1030b, when the user authentication is required, the secure application 132 may identify whether a valid user authentication result exists.

In operation 1040a, when the valid user authentication result exists, the secure application 132 may notify the external electronic device 1000 that the valid user authentication result exists. A message for notifying that the valid user authentication result exists may be transmitted from the secure application 132 to the external electronic device 1000 via at least one of the application 112 or the framework 114 in the normal area 110. However, this is merely an embodiment of the disclosure, and the secure application 132 may directly transmit, to the external electronic device 1000, the message for notifying that the valid user authentication result exists.

In operation 1040b, when a valid user authentication result does not exist, the secure application 132 may request a user authentication result from the user authentication module 134.

In operation 1050, the user authentication module 134 may transmit information about the requested user authentication result to the secure application 132. For example, when the user authentication result corresponding to the request exists in the user authentication module 134, the user authentication module 134 may transmit the user authentication result corresponding to the request. In another example, when the user authentication result corresponding to the request does not exist in the user authentication module 134, the user authentication module 134 may notify that the user authentication result corresponding to the request does not exist.

In operation 1060a, when the user authentication result is valid, the secure application 132 may perform a preset operation corresponding to the user authentication request. When receiving the user authentication result from the user authentication module 134, the secure application 132 may determine whether the received user authentication result satisfies a preset validity condition. However, this is merely an example, and according to another embodiment of the disclosure, if the user authentication module 134 is able to determine a validity condition for the user authentication result, the secure application 132 may assume that the user authentication result transmitted from the user authentication module 134 is valid.

When receiving the valid user authentication result, the secure application 132 may perform a preset operation. For example, the secure application 132 may notify the external electronic device 1000 that the valid user authentication result exists.

In operation 1060b, when the user authentication result is not valid, the secure application 132 may notify the external electronic device 1000 that a valid user authentication result does not exist. A message for notifying that a valid user authentication result does not exist may be transmitted from the secure application 132 to the external electronic device 1000 via at least one of the application 112 or the framework 114 in the normal area 110. However, this is merely one embodiment of the disclosure, and the secure application 132 may directly transmit the message for notifying the external electronic device 1000 that a valid user authentication result does not exist.

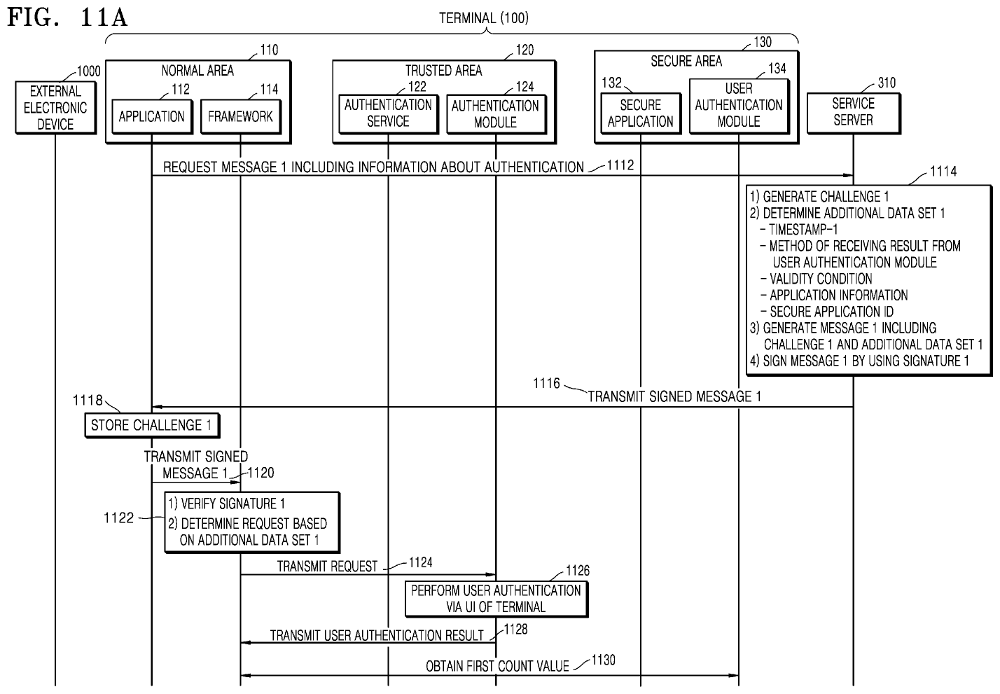

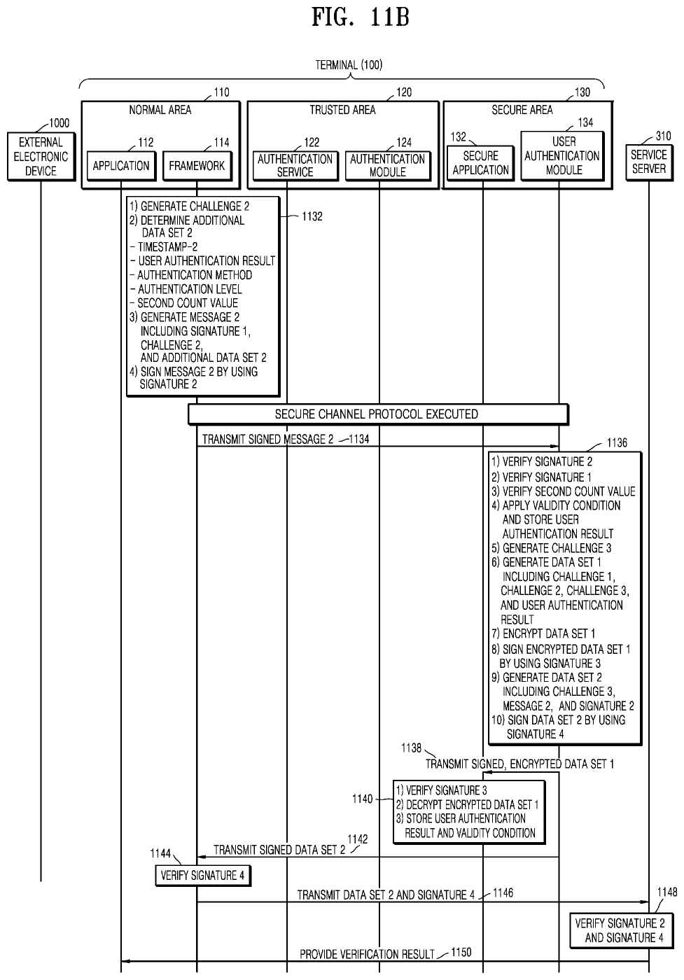

In operation 1070, when the user authentication result is not valid, the secure application 132 may notify the application 112 that a valid user authentication result does not exist. As a result indicating that the user authentication result is not valid is transmitted from the secure application 132, operations for obtaining a user authentication result by performing user authentication need to be performed. This is described with reference to FIGS. 11A and 11B.

FIG. 11A is a flowchart of a method, performed by a terminal, of performing user authentication and providing a user authentication result according to an embodiment of the disclosure.

Referring to FIG. 11A, it is assumed that a user authentication request is received by the terminal 100 from the external electronic device 1000, and as a result of the terminal 1000 identifying whether a valid user authentication result exists according to the request, a valid user authentication result does not exist as in operation 1070 of FIG. 10.

In operation 1112, the application 112 may request message 1 including information about authentication from the service server 310.

In operation 1114, when receiving a request for the message 1, the service server 310 may generate the message 1.

First, the service server 310 may generate challenge 1. For example, the service server 310 may perform an operation of generating challenge 1 by generating a preset number of random bits.

In addition, the service server 310 may determine additional data set 1. The additional data set 1 may include at least one of timestamp 1, a method for receiving a user authentication result from an user authentication module, a validity condition for the user authentication result, application information, or an ID of the secure application. The timestamp 1 may indicate a period for which the user authentication result remains valid after user authentication is performed. In addition, the method of receiving a user authentication result from the user authentication module may include a push method or a poll method. The push method may be a method of providing a user authentication result even without a request, and the poll method may be a method of providing a user authentication result when a certain condition is met by periodically performing a check. The validity condition for the user authentication result may be set in various ways, and may include, for example, a reference counting value or a condition on whether the secure area is reset. The application information may include a certificate for signing the application or a package name of the application. However, the above-described data is merely an example of data constituting the additional data set 1, and the data constituting the additional data set 1 is not limited to the above example.

The service server 310 may generate message 1 including the challenge 1 and the additional data set 1. In addition, the service server 310 may sign message 1 (with signature 1) by using a user authentication request signing key.

In operation 1116, the service server 310 may transmit the signed message 1 to the application 112 in the normal area 110 of the terminal 100.

In operation 1118, the application 112 may store the challenge 1 included in the signed message 1.

In operation 1120, the application 112 may transmit the signed message 1 to the framework 114.

In operation 1122, the framework 114 may determine a request to perform user authentication based on the signed message 1. The framework 114 may verify the user authentication request signing key corresponding to the signature 1 on the signed message 1 by using a user authentication request verification certificate that is a certificate used to verify a user authentication request. In addition, the framework 114 may obtain the additional data set 1 from the signed message 1, and determine a request to perform user authentication based on at least some of the data in the additional data set 1.

In operation 1124, the framework 114 may transmit the request to the authentication module 124 in the trusted area 120.

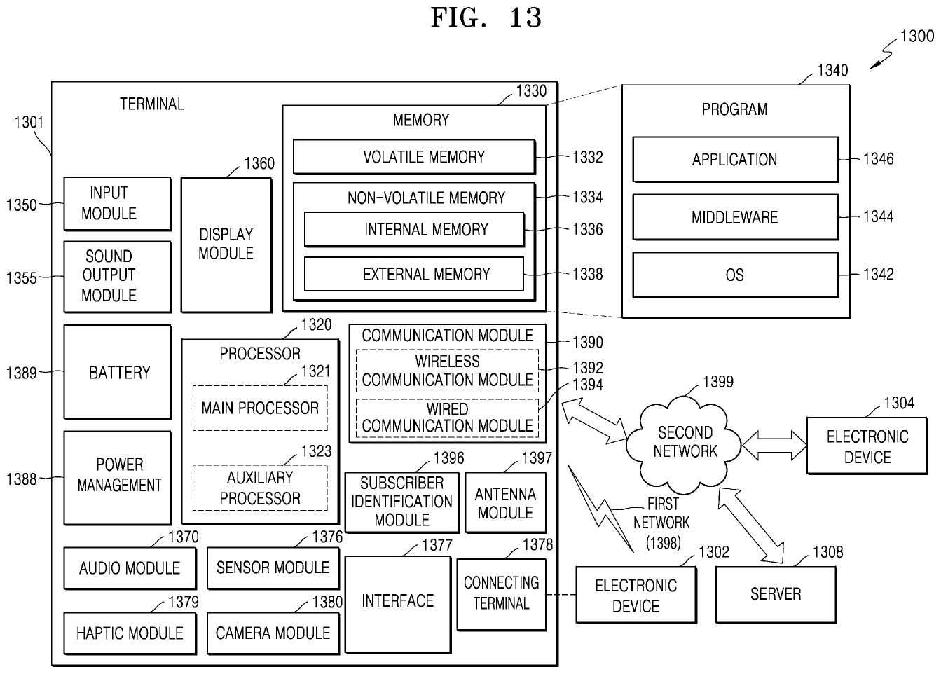

In operation 1126, the authentication module 124 may perform user authentication via a UI of the terminal 100. For example, the authentication module 124 may request a processor of the terminal 100 (e.g., the processor 101 of FIG. 1A or a processor 1320 of FIG. 13) to display a UI for inducing user authentication. Accordingly, the processor 101 or 1320 of the terminal 100 may control a display (e.g., a display module 1360 of FIG. 13) of the terminal to display a UI capable of performing authentication. For example, a UI for inputting a fingerprint or a UI for inputting a PIN number may be displayed on the display module 1360 of the terminal 100.

In operation 1128, the authentication module 124 may transmit a user authentication result to the framework 114 when user authentication is performed via the UI of the terminal 100.

In operation 1130, when receiving the user authentication result, the framework 114 may obtain a first count value from the user authentication module 134. For example, the framework 114 may request the first count value from the user authentication module 134 and obtain in response the first count value from the user authentication module 134. The first count value may be used to verify validity in operation 1136 to be described later.

Subsequent operations are described with reference to FIG. 11B. Like FIG. 11A, FIG. 11B is a flowchart of a method, performed by a terminal, of performing user authentication and providing a user authentication result, according to an embodiment of the disclosure.

Referring to FIG. 11B, in operation 1132, as the first count value is obtained, the framework 114 may generate message 2.

First, the framework 114 may generate challenge 2. For example, the framework 114 may perform an operation of generating challenge 2 by generating a preset number of random bits.

In addition, the framework 114 may determine additional data set 2. The additional data set 2 may include at least one of a timestamp-2, a user authentication result, an authentication method, an authentication level, and a second count value. Here, the second count value may be obtained according to a preset rule, based on the first count value, and for example, the second count value may be obtained by adding 1 to the first count value based on a monotonically increasing function.

The framework 114 may generate message 2 including message 1, signature 1 (a user authentication request signing key), challenge 2, and additional data set 2. The framework 114 may sign message 2 (with signature 2) by using the terminal signing key.

In operation 1134, the framework 114 may transmit the signed message 2 to the user authentication module 134. In this case, a secure channel protocol may be executed between the framework 114 and the user authentication module 134.

In operation 1136, when receiving the signed message 2, the user authentication module 134 may generate data set 1 and data set 2 based on the received message 2.

First, the user authentication module 134 may verify the signature 2 (a terminal signing key) by using a terminal certificate. In addition, when the signature 2 is verified as valid, the user authentication module 134 may verify the signature 1 (the user authentication request signing key) by using a user authentication request verification certificate.

When the signature 1 is verified, the user authentication module 134 may verify the second counter value. For example, the user authentication module 134 may verify the second counter value by identifying whether the second counter value is greater than the first counter value.

When the second counter value is verified as valid, the user authentication module 134 may apply a validity condition and store the user authentication result.

The user authentication module 134 may generate challenge 3. For example, the user authentication module 134 may generate challenge 3 by generating a preset number of random bits.

The user authentication module 134 may generate data set 1 including the challenge 1, the challenge 2, the challenge 3, and the user authentication result. Furthermore, the user authentication module 134 may encrypt the data set 1 by using a user authentication result encryption certificate. The user authentication module 134 may sign the encrypted data set 1 (with signature 3) by using a user authentication result verification signing key.

The user authentication module 134 may generate data set 2 including the challenge 3, the message 2, and the signature 2. The user authentication module 134 may sign the data set 2 (with signature 4) by using the user authentication result verification signing key.

In operation 1138, the user authentication module 134 may transmit the signed, encrypted data set 1 to the secure application 132. Moreover, although it has been described in an embodiment of the disclosure that the user authentication module 134 provides the data set 1 including the user authentication result to one secure application 132, this is merely one embodiment of the disclosure, and according to another embodiment of the disclosure, the user authentication module 134 may provide a user authentication result to at least some of a plurality of secure applications installed in the secure area 130 of the terminal 100.

In operation 1140, the secure application 132 may verify the signature 3 (the user authentication result verification signing key) in the signed, encrypted data set 1 by using a user authentication result verification certificate. When the signature 3 is verified as valid, the secure application 132 may decrypt the encrypted data set 1. For example, the secure application 132 may decrypt the encrypted data set 1 by using a user authentication result decryption signing key. The secure application 132 may store a decryption result and the validity condition and the user authentication result obtained from the data set 1.

In operation 1142, the user authentication module 134 may transmit the signed data set 2 to the framework 114.

In operation 1144, the framework 114 may verify the signature 4 (the user authentication result verification signing key) in the signed data set 2 by using a user authentication result verification certificate.

In operation 1146, when the signature 4 is verified as valid, the framework 114 may transmit the data set 2 and the signature 4 to the application 112.

In operation 1148, the application 112 may transmit, to the service server 310, the data set 2 and the signature 4 received from the framework 114 to the service server 310.

In operation 1150, the service server 310 may verify the signature 2 and the signature 4. For example, the service server 310 may verify the signature 2 by using a terminal manufacturer management certificate and the signature 4 by using a KMS certificate, based on the certificate chain relationship described above with reference to FIG. 3.

In operation 1152, the service server 310 may provide a verification result to the application 112 in the normal area 110. When receiving the verification result from the service server 310, the application 112 may provide a user authentication result for the user authentication request from the external electronic device 1000 described above in operation 1010 of FIG. 10. Accordingly, the application 112 may request the processor 101 or 1320 of the terminal 100 to display a UI for retrying a specified operation (e.g., card payment) that required user authentication. Then, the processor 101 or 1320 of the terminal 100 may control the display module 1360 of the terminal 100 to display the corresponding UI.

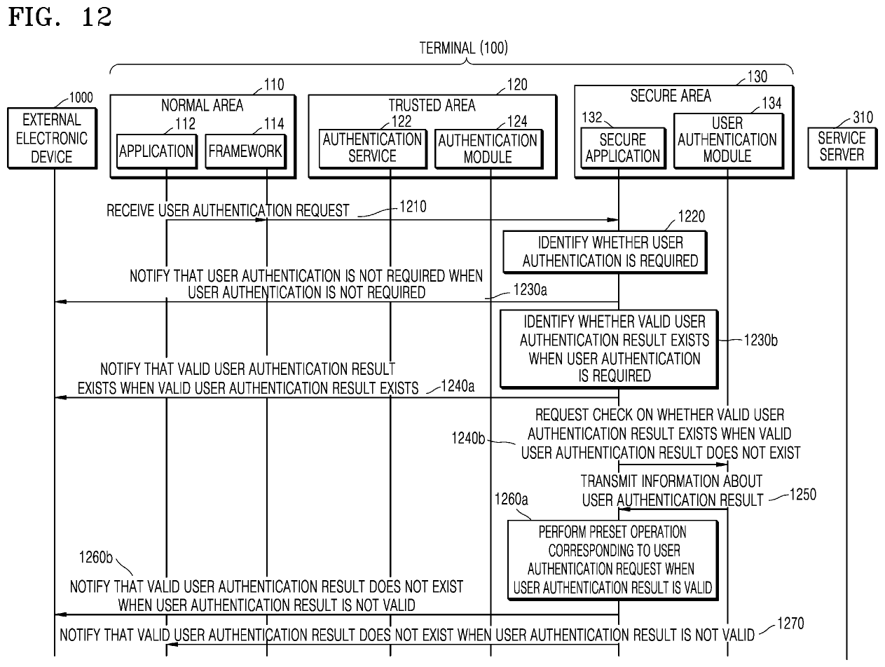

FIG. 12 is a flowchart illustrating an operation performed when a terminal receives a user authentication request from an application in a normal area according to an embodiment of the disclosure.

Referring to FIG. 12, in operation 1210, the application 112 in the normal area 110 of the terminal 100 may transmit a user authentication request to the secure application 132 in the secure area 130. For example, when a user of the terminal 100 performs payment for a specified item while shopping online via the terminal 100, user authentication may be required. In this case, the user authentication request may be transmitted from the application 112 in the normal area 110 of the terminal 100 to the secure application 132.

In operation 1220, when receiving the user authentication request, the secure application 132 may identify whether user authentication is required. For example, when receiving a user authentication request for a specified operation, the secure application 132 may identify whether user authentication is required to perform the specified operation. Here, the user authentication request may include information that allows the terminal 100 to identify the specified operation.

In operation 1230a, when the user authentication is not required, the secure application 132 may notify an external server 1200 that the user authentication is not required. A message for notifying that user authentication is not required may be transmitted from the secure application 132 to the external server 1200 via at least one of the application 112 or the framework 114 in the normal area 110. However, this is merely one embodiment of the disclosure, and the secure application 132 may directly transmit, to the external server 1200, the message for notifying that the user authentication is not required.

Moreover, the external server 1200 may be an online shopping mall server when the user authentication request is generated for a user to pay for an item in an online shopping mall in operation 1210 described above. However, the online shopping mall server is an example of the external server 1200, and the external server 1200 is not limited thereto. According to another embodiment of the disclosure, the message for notifying that the user authentication is not required may be transmitted to a secure area of an external electronic device associated with the external server 1200. In addition, according to another embodiment of the disclosure, the message for notifying that the user authentication is not required may be transmitted to the application 112 in the normal area 110 rather than to the external server 1200.

In operation 1230b, when the user authentication is required, the secure application 132 may identify whether a valid user authentication result exists.

In operation 1240a, when the valid user authentication result exists, the secure application 132 may notify the external server 1200 that the valid user authentication result exists. A message for notifying that the valid user authentication result exists may be transmitted from the secure application 132 to the external server 1200 via at least one of the application 112 or the framework 114 in the normal area 110. However, this is merely an embodiment of the disclosure, and the secure application 132 may directly transmit, to the external server 1200, the message for notifying that the valid user authentication result exists.

According to another embodiment of the disclosure, the message for notifying that the valid user authentication result exists may be transmitted to a secure area of an external electronic device associated with the external server 1200. In addition, according to another embodiment of the disclosure, the message for notifying that the valid user authentication result exists may be transmitted to the application 112 in the normal area 110 rather than to the external server 1200.

In operation 1240b, when a valid user authentication result does not exist, the secure application 132 may request a user authentication result from the user authentication module 134.

In operation 1250, the user authentication module 134 may transmit information about the requested user authentication result to the secure application 132. For example, when the user authentication result corresponding to the request exists in the user authentication module 134, the user authentication module 134 may transmit the user authentication result corresponding to the request. In another example, when the user authentication result corresponding to the request does not exist in the user authentication module 134, the user authentication module 134 may notify that the user authentication result corresponding to the request does not exist.

In operation 1260a, when the user authentication result is valid, the secure application 132 may perform a preset operation corresponding to the user authentication request. When receiving the user authentication result from the user authentication module 134, the secure application 132 may determine whether the received user authentication result satisfies a preset validity condition. However, this is merely an example, and according to another embodiment of the disclosure, if the user authentication module 134 is able to determine a validity condition for the user authentication result, the secure application 132 may assume that the user authentication result transmitted from the user authentication module 134 is valid.

When receiving the valid user authentication result, the secure application 132 may perform a preset operation. For example, the secure application 132 may notify the external server 1200 that the valid user authentication result exists.

In operation 1260b, when the user authentication result is not valid, the secure application 132 may notify the external server 1200 that a valid user authentication result does not exist. A message for notifying that a valid user authentication result does not exist may be transmitted from the secure application 132 to the external server 1200 via at least one of the application 112 or the framework 114 in the normal area 110. However, this is merely one embodiment of the disclosure, and the secure application 132 may directly transmit the message for notifying the external server 1200 that a valid user authentication result does not exist.

According to another embodiment of the disclosure, the message for notifying that a valid user authentication result does not exist may be transmitted to a secure area of an external electronic device associated with the external server 1200. In addition, according to another embodiment of the disclosure, the message for notifying that a valid user authentication result does not exist may be transmitted to the application 112 in the normal area 110 rather than to the external server 1200.

In operation 1270, when the user authentication result is not valid, the secure application 132 may notify the application 112 that a valid user authentication result does not exist. As a result indicating that the user authentication result is not valid is transmitted from the secure application 132, operations for obtaining a user authentication result by performing user authentication need to be performed. In this regard, the same operations as described above with reference to FIGS. 11A and 11B may be performed.

FIG. 13 is a block diagram of a terminal in a network environment according to an embodiment of the disclosure.

Referring to FIG. 13, in a network environment 1300, a terminal 1301 (e.g., the terminal 100 of FIGS. 1A, 1B, 2 to 10, 11A, 11B, and 12) may communicate with an external electronic device 1302 over a first network 1398 (e.g., a short-range wireless communication network), or communicate with at least one of an external electronic device 1304 or a server 1308 over a second network 1399 (e.g., a long-range wireless communication network). According to an embodiment of the disclosure, the terminal 1301 may communicate with the external electronic device 1304 via the server 1308. The external electronic device 1304 may be, for example, the card reader described above with reference to FIG. 10, and the server 1308 may be a service server, a KMS server, or an external server providing a service requiring user authentication to the terminal 1301.

According to an embodiment of the disclosure, the terminal 1301 may include a processor 1320, a memory 1330, an input module 1350, a sound output module 1355, a display module 1360, an audio module 1370, a sensor module 1376, an interface 1377, a connecting terminal 1378, a haptic module 1379, a camera module 1380, a power management module 1388, a battery 1389, a communication module 1390, a subscriber identification module 1396, or an antenna module 1397. In an embodiment of the disclosure, the terminal 1301 may not include at least one of these components (e.g., the connecting terminal 1378) or further include one or more other components. In an embodiment of the disclosure, some of these components (e.g., the sensor module 1376, the camera module 1380, or the antenna module 1397) may be integrated into a single component (e.g., the display module 1360).

For example, the processor 1320 may execute software (e.g., a program 1340) to control at least one other component (e.g., a hardware or software component) of the terminal 1301, which is connected to the processor 1320, and perform various data processing or computations. According to an embodiment of the disclosure, as at least a part of data processing or computation, the processor 1320 may store commands or data received from other components (e.g., the sensor module 1376 or the communication module 1390) in a volatile memory 1332, process the commands or data stored in the volatile memory 1332, and store the resulting data in a non-volatile memory 1334. According to an embodiment of the disclosure, the processor 1320 may include a main processor 1321 (e.g., a central processing unit (CPU) or an application processor (AP)), or an auxiliary processor 1323 (e.g., a graphics processing unit (GPU), a neural processing unit (NPU), an image signal processor, a sensor hub processor, or a communication processor) which is operable independently of or in conjunction with the main processor 1321. For example, when the terminal 1301 includes the main processor 1321 and the auxiliary processor 1323, the auxiliary processor 1323 may be configured to use less power than the main processor 1321 or to be specialized for a specified function. The auxiliary processor 1323 may be implemented separately from or as part of the main processor 1321.

For example, the auxiliary processor 1323 may control at least some of functions or states related to at least one of the components of the terminal 1301 (e.g., the display module 1360, the sensor module 1376, or the communication module 1390) instead of the main processor 1321 while the main processor 1321 is in an inactive (e.g., a sleep) state, or together with the main processor 1321 while the main processor 1321 is in an active state (e.g., executing an application). According to an embodiment of the disclosure, the auxiliary processor 1323 (e.g., the image signal processor or communication processor) may be implemented as a part of another functionally related component (e.g., the camera module 1380 or communication module 1390). According to an embodiment of the disclosure, the auxiliary processor 1323 (e.g., the NPU) may include a hardware structure specialized for processing an artificial intelligence (AI) model. AI models may be created through machine learning. Such machine learning may be performed by the terminal 1301 itself, or through a separate server (e.g., the server 1308). Learning algorithms may include, for example, supervised learning, unsupervised learning, semi-supervised learning, or reinforcement learning, but are not limited thereto. An AI model may include a plurality of artificial neural network layers. An artificial neural network may include, but is not limited to, one of a deep neural network (DNN), a convolutional neural network (CNN), a recurrent neural network (RNN), a restricted Boltzmann machine (RBM), a deep belief network (DBN), a bidirectional recurrent DNN (BRDNN), a deep Q-network (DQN), or a combination of two or more of the stated networks. The AI model may include a software structure in addition to or instead of the hardware structure.

The memory 130 may store various types of data used by at least one component (e.g., the processor 1320 or the sensor module 1376) of the terminal 1301. The various types of data may include, for example, software (e.g., the program 1340) and input data or output data for a command related thereto. The memory 130 may include the volatile memory 1332 or the non-volatile memory 1334.

The program 1340 may be stored in the memory 130 as software and include, for example, an OS, middleware 1344, or an application 1346.

The input module 1350 may receive a command or data to be used by a component (e.g., the processor 1320) of the terminal 1301 from outside of the terminal 1301 (e.g., a user). The input module 1350 may include, for example, a microphone, a mouse, a keyboard, a key (e.g., a button), or a digital pen (e.g., a stylus pen).

The sound output module 1355 may output sound signals to the outside of the terminal 1301. The sound output module 1355 may include, for example, a speaker or a receiver. The speaker may be used for general purposes, such as playing multimedia or playing recordings. The receiver may be used to receive incoming calls. According to an embodiment of the disclosure, the receiver may be implemented separately from or as a part of the speaker.

The display module 1360 may visually provide information to the outside of the terminal 1301 (e.g., the user). The display module 1360 may include, for example, a display, a hologram device, or a projector and a control circuitry for controlling a corresponding device. According to an embodiment of the disclosure, the display module 1360 may include a touch sensor configured to detect a touch or a pressure sensor configured to measure the intensity of a force generated by the touch.

The audio module 1370 may convert a sound into an electrical signal or vice versa. According to an embodiment of the disclosure, the audio module 1370 may obtain a sound via the input module 1350, or output the sound via the sound output module 1355 or an external electronic device (e.g., the external electronic device 1302) (e.g., a speaker or a headphone) connected directly or wirelessly to the terminal 1301.

The sensor module 1376 may detect an operating state (e.g., power or temperature) of the terminal 1301 or an external environmental state (e.g., a user's state), and generate an electrical signal or data value corresponding to the detected state. According to an embodiment of the disclosure, the sensor module 1376 may include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols that may be used by the terminal 1301 to directly or wirelessly connect with an external electronic device (e.g., the external electronic device 1302). According to an embodiment of the disclosure, the interface 1377 may include, for example, a high-definition multimedia interface (HDMI), a universal serial bus (USB) interface, an SD card interface, or an audio interface.

The connecting terminal 1378 may include a connector via which the terminal 1301 may be physically connected to an external electronic device (e.g., the external electronic device 1302). According to an embodiment of the disclosure, the connecting terminal 1378 may include, for example, an HDMI connector, a USB connector, an SD card connector, or an audio connector (e.g., a headphone connector).

The haptic module 1379 may convert electrical signals into mechanical stimuli (e.g., vibration or movement) or electrical stimuli that a user can perceive through tactile sensation or kinesthetic sensations. According to an embodiment of the disclosure, the haptic module 1379 may include, for example, a motor, a piezoelectric element, or an electric stimulator.

The camera module 1380 may capture still images or moving images. According to an embodiment of the disclosure, the camera module 1380 may include one or more lenses, image sensors, image signal processors, or flashes.

The power management module 1388 may manage power supplied to the terminal 1301. According to an embodiment of the disclosure, the power management module 1388 may be implemented as at least a part of, for example, a power management integrated circuit (PMIC).

The battery 1389 may supply power to at least one component of the terminal 1301. According to an embodiment of the disclosure, the battery 1389 may include, for example, a primary cell which is non-rechargeable, a secondary cell which is rechargeable, or a fuel cell.

The communication module 1390 may support establishing a direct (e.g., wired) communication channel or a wireless communication channel between the terminal 1301 and an external electronic device (e.g., the external electronic device 1302, the external electronic device 1304, or the server 1308) and performing communication via the established communication channel. The communication module 1390 may include one or more communication processors that operate independently of the processor 1320 (e.g., an AP) and support direct (e.g., wired) communication or wireless communication. According to an embodiment of the disclosure, the communication module 1390 may include a wireless communication module (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device 1304 over the first network 1398 (e.g., a short-range communication network, such as Bluetooth, WFD, or IrDA) or the second network 1399 (e.g., a long-range communication network, such as a legacy cellular network, a 5G network, a next-generation communication network, the Internet, or a computer network (e.g., a LAN or wide area network (WAN)). These various types of communication modules may be integrated into a single component (e.g., a single chip) or be implemented as a plurality of separate components (e.g., a plurality of chips). A wireless communication module 1392 may identify or authenticate the terminal 1301 within a communication network, such as the first network 1398 or the second network 1399 by using subscriber information (e.g., an international mobile subscriber identifier (IMSI)) stored in a subscriber identification module 1396.

The wireless communication module 1392 may support a 5G network after a 4^{th}-generation (4G) network and a next-generation communication technology, such as new radio (NR) access technology. The NR access technology may support high-speed transfer of large volume of data (enhanced mobile broadband (eMBB)), minimization of power consumption for a terminal and massive access by a large number of terminals (massive machine type communications (mMTC)), or high reliability and low latency (ultra-reliable and low latency communications (URLLC)). For example, the wireless communication module 1392 may support high frequency bands (e.g., millimeter-wave (mmWave) bands) to achieve a high data rate. The wireless communication module 1392 may support various technologies for securing performance in high frequency bands, such as beamforming, massive multiple-input and multiple-output (MIMO), full dimensional MIMO (FD-MIMO), array antennas, analog beam-forming, or large-scale antennas. The wireless communication module 1392 may support various requirements defined for the terminal 1301, an external electronic device (e.g., the external electronic device 1304), or a network system (e.g., the second network 1399). According to an embodiment of the disclosure, the wireless communication module 1392 may support a peak data rate (e.g., 20 gigabits per second (Gbps) or more) for realizing eMBB, a loss coverage (e.g., up to 164 decibels (dB) for realizing mMTC, or user-plane latency for realizing URLLC (e.g., downlink (DL) and uplink (UL) latency of 0.5 milliseconds (ms) or less or round trip latency of 1 ms or less).

The antenna module 1397 may transmit or receive signals or power to or from the outside (e.g., an external electronic device). According to an embodiment of the disclosure, the antenna module 1397 may include an antenna including a radiating element including a conductive material or a conductive pattern formed in or on a substrate (e.g., a printed circuit board (PCB)). According to an embodiment of the disclosure, the antenna module 1397 may include a plurality of antennas (e.g., an array antenna). In this case, at least one antenna appropriate for a communication method used in a communication network, such as the first network 1398 or the second network 1399, may be selected by, for example, the communication module 1390 from among the plurality of antennas. A signal or power may be transmitted or received between the communication module 1390 and an external electronic device via the selected at least one antenna. According to an embodiment of the disclosure, a component (e.g., a radio frequency integrated circuit (RFIC)) other than the radiating element may be additionally formed as a part of the antenna module 1397. According to various embodiments of the disclosure, the antenna module 1397 may form an mmWave antenna module. According to an embodiment of the disclosure, the mmWave antenna module may include a PCB, an RFIC disposed on or adjacent to a first surface (e.g., a bottom surface) of the PCB and capable of supporting a specified high frequency band (e.g., an mmWave band), and a plurality of antennas (e.g., array antenna) disposed on or adjacent to a second surface (e.g., a top surface or a side) of the PCB and capable of transmitting or receiving signals in the specified high frequency band.

At least some of the components may be connected to each other and exchange signals (e.g., commands or data) with each other by using a communication scheme between peripheral devices (e.g., via a bus, general-purpose input and output (GPIO), serial peripheral interface (SPI), or mobile industry processor interface (MIPI)).

According to an embodiment of the disclosure, commands or data may be transmitted or received between the terminal 1301 and the external electronic device 1304 via the server 1308 connected to the second network 1399. Each of the external electronic devices 1302 or 1304 may be a device of the same type as or a different type from the terminal 1301. According to an embodiment of the disclosure, all or some of operations performed by the terminal 1301 may be performed by one or more of the external electronic devices 1302, 1304, or 1308. For example, when the terminal 1301 needs to perform a certain function or service automatically or in response to a request from a user or another device, the terminal 1301 may request the one or more external electronic devices to perform at least a part of the function or service instead of or in addition to executing the function or service on its own. The one or more external electronic devices receiving the request may perform at least a part of the requested function or service, or an additional function or service related to the request, and transmit a result of the performing to the terminal 1301. The terminal 1301 may provide the result as at least part of a response to the request with or without further processing of the result. To this end, for example, cloud computing, distributed computing, mobile edge computing (MEC), or client-server computing technology may be used. The terminal 1301 may provide ultra-low latency services by using, for example, distributed computing or mobile edge computing. In another embodiment of the disclosure, the external electronic device 1304 may include an Internet of things (IoT) device. The server 1308 may be an intelligent server using machine learning and/or neural networks. According to an embodiment of the disclosure, the external electronic device 1304 or the server 1308 may be included in the second network 1399. The terminal 1301 may be applied to intelligent services (e.g., smart homes, smart cities, smart cars, or health care) based on 5G communication technology and IoT-related technology.

Terminals according to various embodiments disclosed herein may be various types of devices. The terminals may include, for example, portable communication devices (e.g., smart phones) computer devices, portable multimedia devices, portable medical devices, cameras, wearable devices, or home appliances. According to an embodiment of the disclosure, the terminals are not limited to the above-described devices.

It should be appreciated that various embodiments of the disclosure and the terms used therein are not intended to limit the technical features set forth herein to specific embodiments and include various changes, equivalents, or alternatives for the corresponding embodiments. In relation to the description of the drawings, like reference numerals may be used to represent like elements or related elements. As used herein, each of expressions, such as “A or B,” “at least one of A and B,” “at least one of A or B,” “A, B, or C,” “at least one of A, B, and C,” and “at least one of A, B, or C,” may include any one of the items stated together in a corresponding one of the expressions, or all possible combinations thereof. Terms, such as “1st,” “2nd,” or “first” or “second” may be used to simply distinguish a corresponding component from another component and do not limit the components in any other respect (e.g., importance or order). When a component (e.g., a first component) is referred to, with or without the term “functionally” or “communicatively”, as being “coupled” or “connected” to another component (e.g., a second component), it means that the component may be coupled or connected to the other component directly (e.g., in a wired manner), wirelessly, or via a third component.

As used in various embodiments of this document, the term “module” may include a unit implemented in hardware, software, or firmware, and may be used interchangeably with another term, such as logic, logic block, component, or circuitry. A module may be an integrally formed component, or a minimum unit or a part of the component configured to perform one or more functions. For example, according to an embodiment of the disclosure, the module may be implemented in a form of an application-specific integrated circuit (ASIC).

Various embodiments set forth herein may be implemented as software (e.g., the program 1340) including one or more instructions stored in a storage medium (e.g., an internal memory 1336 or an external memory 1338) that is readable by a machine (e.g., the terminal 1301). For example, a processor (e.g., the processor 1320) of a machine (e.g., the terminal 1301) may call at least one of the stored one or more instructions from the storage medium and execute the called at least one instruction. This enables the machine to be operated to perform at least one function according to the called at least one instruction. The one or more instructions may include code generated by a complier or code executable by an interpreter. The machine-readable storage medium may be provided in the form of a non-transitory storage medium. In this regard, the term ‘non-transitory’ only means that the storage medium is a tangible device and does not include a signal (e.g., an electromagnetic wave), and the term does not differentiate between where data is semi-permanently stored in the storage medium and where the data is temporarily stored in the storage medium.

According to an embodiment of the disclosure, methods according to various embodiments of the disclosure may be included in a computer program product when provided. The computer program product may be traded, as a product, between a seller and a buyer. The computer program product may be distributed in the form of a machine-readable storage medium (e.g., a compact disc-ROM (CD-ROM)) or distributed (e.g., downloaded or uploaded) on-line via an application store (e.g., Google™ Play Store™) or directly between two user devices (e.g., smartphones). For online distribution, at least a part of the computer program product may be at least transiently stored or temporally generated in the machine-readable storage medium, such as memory of a server of a manufacturer, a server of an application store, or a relay server.

According to various embodiments of the disclosure, each component (e.g., a module or a program) of the above-described components may include a single entity or a plurality of entities, some of which may be separately disposed in other components. According to various embodiments of the disclosure, one or more of the above-described components or one or more operations may be omitted, or one or more other components or operations may be added. Alternatively or additionally, a plurality of components (e.g., modules or programs) may be integrated into a single component. In such a case, the integrated component may perform one or more functions of each of the plurality of components in the same or similar manner as they are performed by a corresponding one of the plurality of components before the integration. According to various embodiments of the disclosure, operations performed by a module, a program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method, performed by a terminal, of performing user authentication, the method comprising:
receiving, by one secure application among at least one secure application installed in a secure area of the terminal, a user authentication request;
identifying whether a valid user authentication result corresponding to the user authentication request exists;
in response to there being no valid user authentication result corresponding to the user authentication request, requesting, by the secure application that has received the user authentication request, a user authentication result from a user authentication module installed in the secure area; and
providing, by the user authentication module, a user authentication result corresponding to the user authentication request to the secure application that has received the user authentication request or to the at least one secure application installed in the secure area of the terminal.

2. The method of claim 1, wherein the user authentication request is received from an external electronic device or from an application installed in a normal area of the terminal.

3. The method of claim 1, further comprising:
when the user authentication result received from the user authentication module is not valid, performing, by an authentication module installed in a trusted area of the terminal, user authentication via a user interface of the terminal;
signing, by a framework in a normal area of the terminal, a first message including a user authentication result obtained as a result of the performing of the user authentication by using a terminal signing key;
receiving, by the user authentication module, the first message signed using the terminal signing key from the framework in the normal area; and
in response to the first message signed using the terminal signing key being identified as valid, providing, by the user authentication module, the obtained user authentication result to the secure application that has received the user authentication request or to the at least one secure application installed in the secure area of the terminal.

4. The method of claim 3, further comprising:
receiving, by the user authentication module, from a service server, identification information about a certificate proving a provider of one of the at least one secure application installed in the secure area of the terminal;
verifying, by the user authentication module, whether the received identification information corresponds to prestored identification information;
in response to the received identification information not corresponding to the prestored identification information, transmitting, by the user authentication module, the received identification information to a key management system server via the framework in the normal area of the terminal; and
in response to the existence of a certificate proving a service provider corresponding to the received identification information in the key management system server, receiving, by the user authentication module, the certificate proving the service provider from the key management system server.

5. The method of claim 1, further comprising:
receiving, by a framework in a normal area of the terminal, identification information about a certificate proving a provider of one of the at least one secure application installed in the secure area of the terminal;
in response to there being no certificate corresponding to the identification information in the framework in the normal area of the terminal, requesting the certificate corresponding to the identification information from the user authentication module; and
transmitting, by the user authentication module, information about whether the requested certificate exists or the requested certificate to the framework in the normal area of the terminal.

6. The method of claim 1, further comprising:
receiving, by a framework in a normal area of the terminal, identification information about a certificate for verifying a user authentication request;
in response to there being no certificate corresponding to the identification information does not exist in the framework in the normal area of the terminal, requesting the certificate corresponding to the identification information from the user authentication module; and
transmitting, by the user authentication module, information about whether the requested certificate exists or the requested certificate to the framework in the normal area of the terminal.

7. The method of claim 6, further comprising:
signing, by the user authentication module, a message including a certificate corresponding to a user authentication module key by using the user authentication module key; and
transmitting the message signed using the user authentication module key to the at least one secure application installed in the secure area of the terminal,
wherein the signed message is transmitted from the at least one secure application to a service server corresponding to the at least one secure application via the framework, and
wherein the signed message is used by the service server to verify the user authentication result provided by the user authentication module.

8. A terminal for performing user authentication, the terminal comprising:
a communication module;
a memory storing one or more instructions;
at least one processor configured to execute the one or more instructions stored in the memory; and
a secure circuitry connected to the at least one processor,
wherein one secure application among at least one secure application installed in a secure area of the secure circuitry is configured to:
receive a user authentication request via a framework in a normal area of the processor,
identify whether a valid user authentication result corresponding to the user authentication request exists, and
in response to there being no valid user authentication result corresponding to the user authentication request, request a user authentication result from a user authentication module installed in the secure area, and
wherein the user authentication module is configured to provide a user authentication result corresponding to the user authentication request to the secure application that has received the user authentication request or to the at least one secure application installed in the secure area of the terminal.

9. The terminal of claim 8, wherein the user authentication request is received from an external electronic device via the communication module or received from an application installed in the normal area of the processor.

10. The terminal of claim 8,
wherein, when the user authentication result received from the user authentication module is not valid, an authentication module installed in a trusted area of the processor is configured to perform user authentication via a user interface of the terminal,
wherein the framework is configured to sign a first message including a user authentication result obtained as a result of the performing of the user authentication by using a terminal signing key, and
wherein the user authentication module is further configured to:
receive, from the framework, the first message signed using the terminal signing key, and
in response to the first message signed using the terminal signing key being identified as valid, provide the obtained user authentication result to the secure application that has received the user authentication request or to the at least one secure application installed in the secure area of the terminal.

11. The terminal of claim 8, wherein the user authentication module is further configured to:
receive, from a service server, identification information about a certificate proving a provider of one of the at least one secure application installed in the secure area of the terminal,
verify whether the received identification information corresponds to prestored identification information,
in response to the received identification information not corresponding to the prestored identification information, transmit the received identification information to a key management system server via the framework in the normal area of the terminal, and
in response to the existence of a certificate proving a service provider corresponding to the received identification information in the key management system server, receive the certificate proving the service provider from the key management system server.

12. The terminal of claim 8,
wherein, the framework is configured to:
receive identification information about a certificate proving a provider of one of the at least one secure application installed in the secure area of the terminal, and
in response to there being no certificate corresponding to the identification information, request the certificate corresponding to the identification information from the user authentication module, and
wherein the user authentication module is further configured to transmit, to the framework, information about whether the requested certificate exists or the requested certificate.

13. The terminal of claim 8,
wherein, the framework is configured to:
receive identification information about a certificate for verifying a user authentication request, and
in response to there being no certificate corresponding to the identification information, request the certificate corresponding to the identification information from the user authentication module, and
wherein the user authentication module is further configured to transmit, to the framework, information about whether the requested certificate exists or the requested certificate.

14. The terminal of claim 8,
wherein the user authentication module is further configured to:
sign a message including a certificate corresponding to a user authentication module key by using the user authentication module key, and
transmit the message signed using the user authentication module key to the at least one secure application installed in the secure area of the terminal,
wherein the signed message is transmitted from the at least one secure application to a service server corresponding to the at least one secure application via the framework, and
wherein the signed message is used by the service server to verify the user authentication result provided by the user authentication module.

15. At least one non-transitory computer program product comprising a recording medium having stored therein a program that causes a terminal to perform a method of performing user authentication, the method comprising:
receiving, by one secure application among at least one secure application installed in a secure area of the terminal, a user authentication request;
identifying whether a valid user authentication result corresponding to the user authentication request exists;
in response to there being no valid user authentication result corresponding to the user authentication request, requesting, by the secure application that has received the user authentication request, a user authentication result from a user authentication module installed in the secure area; and
providing, by the user authentication module, a user authentication result corresponding to the user authentication request to the secure application that has received the user authentication request or to the at least one secure application installed in the secure area of the terminal.

16. The at least one non-transitory computer program product of claim 15, wherein the user authentication request is received from an external electronic device or from an application installed in a normal area of the terminal.

17. The at least one non-transitory computer program product of claim 15, further comprising:
when the user authentication result received from the user authentication module is not valid, performing, by an authentication module installed in a trusted area of the terminal, user authentication via a user interface of the terminal;
signing, by a framework in a normal area of the terminal, a first message including a user authentication result obtained as a result of the performing of the user authentication by using a terminal signing key;
receiving, by the user authentication module, the first message signed using the terminal signing key from the framework in the normal area; and
in response to the first message signed using the terminal signing key being identified as valid, providing, by the user authentication module, the obtained user authentication result to the secure application that has received the user authentication request or to the at least one secure application installed in the secure area of the terminal.

18. The at least one non-transitory computer program product of claim 17, further comprising:
receiving, by the user authentication module, from a service server, identification information about a certificate proving a provider of one of the at least one secure application installed in the secure area of the terminal;
verifying, by the user authentication module, whether the received identification information corresponds to prestored identification information;
in response to the received identification information not corresponding to the prestored identification information, transmitting, by the user authentication module, the received identification information to a key management system server via the framework in the normal area of the terminal; and
in response to the existence of a certificate proving a service provider corresponding to the received identification information in the key management system server, receiving, by the user authentication module, the certificate proving the service provider from the key management system server.

19. The at least one non-transitory computer program product of claim 15, further comprising:
receiving, by a framework in a normal area of the terminal, identification information about a certificate proving a provider of one of the at least one secure application installed in the secure area of the terminal;
in response to there being no certificate corresponding to the identification information in the framework in the normal area of the terminal, requesting the certificate corresponding to the identification information from the user authentication module; and
transmitting, by the user authentication module, information about whether the requested certificate exists or the requested certificate to the framework in the normal area of the terminal.

20. The at least one non-transitory computer program product of claim 15, further comprising:
receiving, by a framework in a normal area of the terminal, identification information about a certificate for verifying a user authentication request;
in response to there being no certificate corresponding to the identification information does not exist in the framework in the normal area of the terminal, requesting the certificate corresponding to the identification information from the user authentication module; and
transmitting, by the user authentication module, information about whether the requested certificate exists or the requested certificate to the framework in the normal area of the terminal.
